(19) United States
(12) Patent Application Publication
(10) Pub. No.: US 2019/0232279 A1
(43) Pub. Date: Aug. 1, 2019

(54) PERFORATED LABEL OVER A COMPRESSIBLE POUCH

(71) Applicant: GenMark Diagnostics, Inc., Carlsbad, CA (US)

(72) Inventors: Tyler David Jensen, San Diego, CA (US); Sean Ford, Oceanside, CA (US); Eric Villarreal, Carlsbad, CA (US); Andrew David Fish, Parker, CO (US)

(73) Assignee: GenMark Diagnostics, Inc., Carlsbad, CA (US)

(21) Appl. No.: 15/881,486

(22) Filed: Jan. 26, 2018

(51) Int. Cl. B01L 3/00

(52) U.S. Cl. CPC B01L 3/502707; B01L 2300/0883; B01L 2200/141

(57) ABSTRACT

The present disclosure relates to methods and devices for displacing a liquid, gas or solid from a compressible pouch. The compressible pouch is housed in an external housing with holes over the compressible pouch and a label over the external housing/holes and compressible pouch. The label comprises perforations configured to allow a chad to separate but not detach from the label. When a compressive force is applied to the label, the chad separates (but does not detach) from the label allowing the compressive force to be applied to the compressible pouch below and force the fluid, gas or solid from the compressible pouch.

The invention relates to the field of molecular diagnostic devices for the detection of target analytes.

### BACKGROUND OF THE INVENTION

Pressure sensitive labels are used in a wide variety of labeling applications. Many of these labels are used on semi-rigid or plastic containers or tubes that would be frequently squeezed during consumer use. See WO2013055461. But labels with high elasticity are not elastic enough to allow a compression mechanism to push on a label through to a compressible blister below to push fluid, gas or a solid out of the blister. Elastic labels tear unevenly leading to uneven compression on the blister below and uneven fluid dispersal. When elastic labels tear they can stick to the compression mechanism or separate from the label and jam the compression mechanism or instrumentation operating the compression mechanism.

Use of compressible pouches or blisters provide an effective means for fluid delivery such as reagents, butlers, medicine, food, or environmental fluids. But, the use of such systems is challenging because compressible pouches can rupture, are not stably connected etc. To solve these problems, compressible pouches are placed into boxes or containers/cartridges. A drawback to using such encasements is that they provide a barrier to controllably release fluid, gases or solids from the compressible pouch. Systems have been described wherein housings have open areas over at least part of the compressible blister. See U.S. Patent Publication no. 20140194305. But when such housings with open areas are used, the space available to provide cartridge information, patient information etc. is limited. Further, in such embodiments, the compressible blister remains exposed to the environment, i.e., unprotected.

Fluidic cartridges with labels are known See U.S. Pat. No. 6,656,428. Perforated labels are known. See U.S. Patent Publication US20160158746. U.S. Patent Publication US20160158746 discloses two types of perforations: (1) A perforation forming a closed circle such that the chad is designed to break away from the label. See paragraph [0018] therein. As discussed above, when the chad breaks away, it can jam the compression mechanism or instrument operating the compression mechanism; or (2) perforations forming one or more lines crossing the recess. Such embodiments cause tearing of the label and uneven compression of the compressible pouch. Indeed in the embodiment with one or more lines crossing the recess, there are multiple small pieces which can flake off and jam compression mechanism.

The present invention is designed to overcome the above issues and in particular is designed to achieve protection of the compressible pouch whilst also achieving accurate flow rates.

### BRIEF SUMMARY OF THE INVENTION

Disclosed herein are fluid delivery apparatuses, systems and methods. Specifically, disclosed herein is a cartridge with a perforated label over a compressible pouch.

### BRIEF DESCRIPTION OF THE DRAWINGS

FIG. 1 shows a top perspective view of the cartridge and label according to a first embodiment;

FIG. 2 shows a top plan view thereof;

FIG. 3 shows a top perspective view of the cartridge and label according to a second embodiment;

FIG. 4 shows a top plan view thereof

FIG. 5 shows a top perspective view of the cartridge and label according to a third embodiment;

FIG. 6 shows a top plan view thereof;

FIG. 7 shows a top perspective view of the cartridge and label according to a fourth embodiment;

FIG. 8 shows a top plan view thereof;

FIG. 9: Shows a label design. The dark gray region of the label includes an adhesive; the light gray region of the label with dashed lines does not include an adhesive; and white is a cut through. FIG. 9a shows a top plan view of the label. FIG. 9b shows a perspective view of the label. FIG. 9c shows a side view of the label.

FIG. 10: Shows a label design. In this embodiment both the dark gray region and light gray region are adhesive.

FIG. 11: FIG. 11a shows a label design. The dashed lines indicate perforations and the solid lines indicate thru cuts. FIG. 11b shows the label applied to a cartridge

FIG. 12: Shows a label design. FIG. 12a, is a top plan view of the label and the serpentine and cross perforations are shown as solid lines. In this embodiment, there are no thru cuts. FIG. 12b shows a side view of the label.

FIG. 13: is a schematic of a compressor ready to compress a compressible pouch holding a solid component. As can be seen, the cartridge comprises a compressible pouch, external housing with holes over the compressible pouch and a label. The perforations in this embodiment form a serpentine separation line.

FIG. 14: is a schematic of a compressor compressing the compressible pouch holding a solid component. The compressor presses on the label releasing the chad from the label (but not detaching it). The perforations in this embodiment form a serpentine separation line and hanging chad. The chad becomes a hanging chad which hangs down because of the serpentine perforation connecting the hanging chad to the label. The hanging chad has an accordion like appearance.

FIG. 15: is a schematic of a compressor ready to compress a compressible pouch holding a fluid component. As can be seen, the cartridge comprises a compressible pouch, external housing with holes over the compressible pouch and a label. The perforations in this embodiment form a serpentine separation line. While the perforations in the label above the sphere blister form a cross.

FIG. 16: is a schematic of a compressor compressing the compressible pouch holding a fluid component. The compressor presses on the label releasing the chad from the label (but not detaching it). The perforations in this embodiment form a serpentine separation line and hanging chad.

FIG. 17: Shows new and used consumables. FIG. 17a shows an unused or new consumable. FIG. 17b shows an unused or new consumable. In both embodiments the label is intact, i.e., it has not been compressed or deformed. FIG. 17c shows a used consumable with the label over the blister deformed because the bay compressor pressed on the label and blister to either push a sphere ball out of the blister or push fluid out of the fluid filed blister.

FIG. 18: Shows a schematic of a hybridization complex.

FIG. 19: Shows a schematic of the bi-directional LIS reporting.

FIG. 20: Shows a schematic of “Order-to-report.” The clock time stamps are commonly documented in hospital and laboratory information systems.

### DEFINITIONS

The term “label” simply refers to a film such as a piece of paper, fabric, plastic, or similar material attached to an object and giving information about it. In some cases the label has an adhesive bound thereto.

“Compressible element” means an element that can be compressed. Herein, the compressible element is filled with fluid, gas or a solid. In some cases, the compressible element is filled with a non-compressible/non-deformable component. A ball bearing which can be pushed into a recess is a type of compressible component disclosed herein (the ball bearing being made of steel, plastic, wood, polymers, or any other useful material). Food and medicine are other types of non-compressible components disclosed herein. The compressible element is also referred to as a squeezable element or a mechanically actuateable mechanism.

“Blisters” or “pouches” are a type of compressible element. Blisters and pouches include sealed units which store fluids, gases or solids prior to delivery and have been used to store and subsequently deliver fluids to microfluidic devices. In order to deliver the fluid, gas or solid to a target location, a user breaks the seal of the unit/blister. The seal may be broken by a user manually applying a force to the seal or by way of an actuator and compressor applying pressure. Methods of breaking a blister are known to those in the art see e.g. U.S. Publication no. 2016-0339426 which is hereby incorporated by reference in its entirety. Fluid in the blister can include but is not limited to blood or blood products, such as plasma, reagents, buffers, food, environmental liquids or medicines. Solids in the blister can include tissue, reagents, buffers, food, environmental liquids, medicines as well as a blister piercing mechanism such as a spike or a ball bearing. Gases in the blister can include reagents, buffers, food, environmental gases, or medicines.

As used herein a “chad” is the portion of the label covering the recess formed by the external housing. When the chad separates from the rest of the label, it does not entirely or completely detach. Other terms that can be used to define this separation (but non-detachment) are fragmented, ruptured, parted, cracked, disjointed, disengaged. Stated another way the chad does not break away from the cartridge, it is not breakable. The chad can be understood to be the region of the label over the blister. The chad can also be understood to be the region of the label formed by the separation line. The chad is also referred to as the portion of the label over the compressible element, a topper, spiral cap, spiral overlay, release cap or the like. Because of the perforations connecting the chad to the label, the label is deformable, and pressure sensitive.

“Hanging chad” means the chad when it is separated (but not detached) from the rest of the label. Hanging chads are also referred to as nibs, and pregnant chad.

A “Compressor” is any mechanism known in the art used to compress a blister and force the fluid, gas or solid within the blister out. The compressor applies a compressive force. The compressor can be internal to the cartridge or external. The compressor can be part of an instrument/machine that the cartridge is placed into (see e.g. U.S. publication no. 2016-0339426 which is hereby incorporated by reference in its entirety) or can be an independent compressor not part of a larger unit. The compressor can be a mechanical means or a non-mechanical means such as a finger. The compressor is also referred to as a compression mechanism. The compressor is said to be inserted into the housing recess to actuate the compressible element.

As used herein, the term “cartridge” or “consumable” means a sample processing unit for performing a process on a sample contained in the device. The cartridge can be designed for insertion into a mechanism instrument or it can be a stand-alone cartridge to be used independent of a mechanism/instrument. When the fluid, gas or solid is expelled from the blister it may leave the cartridge via an exit port. From there it may enter the environment or it may enter another cartridge assembly such as a reaction module. Reaction modules are known in the art, see for example, U.S. Pat. No. 9,598,722 which is herein incorporated by reference in its entirety.

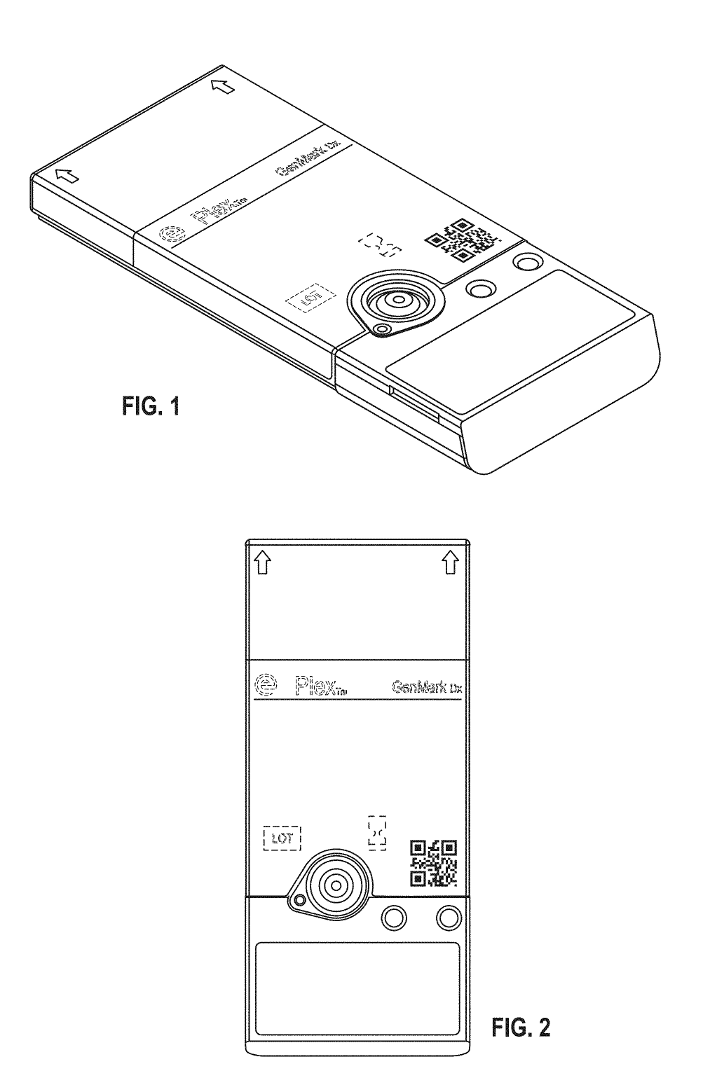

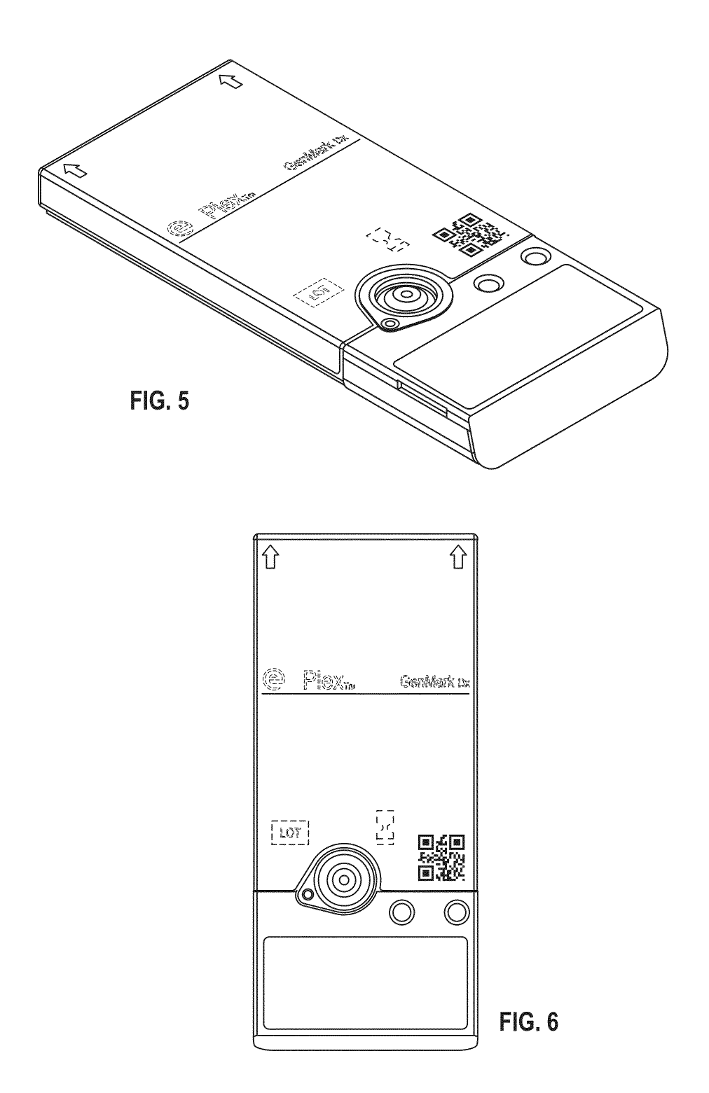

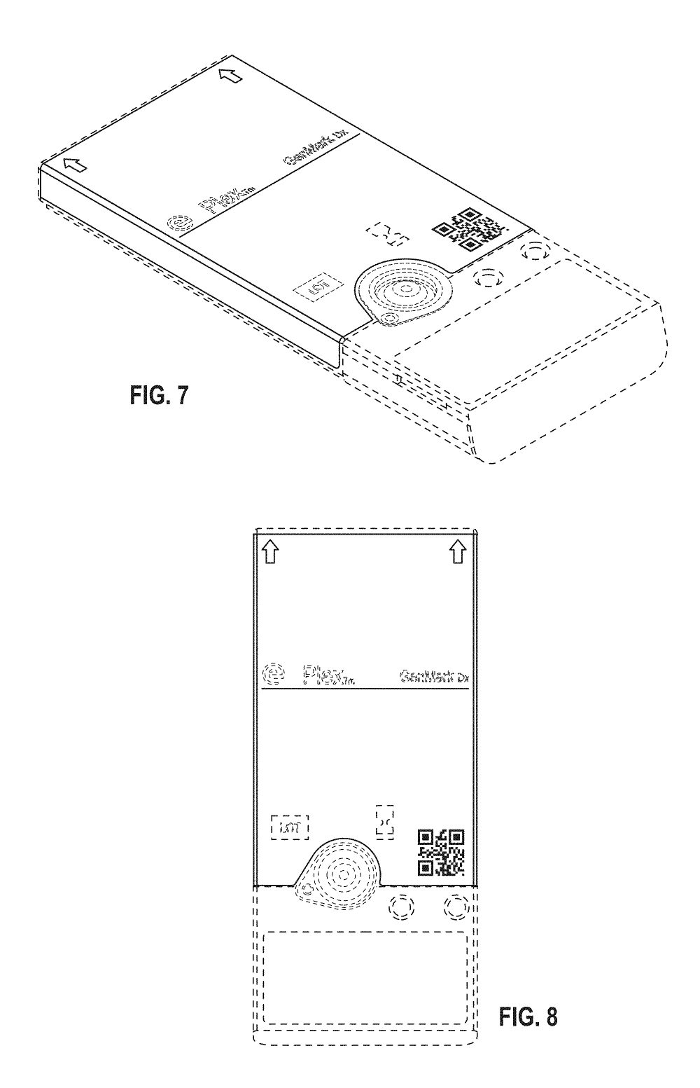

A “Panel cartridge” is a self-contained cartridge/consumable that includes the necessary components to perform a single Panel test. A “panel cartridge” or “panel consumable” is a cartridge for performing assays in a closed sample preparation and reaction system as described in U.S. Pat. No. 9,598,722 which is herein incorporated by reference in its entirety. FIG. 1 of U.S. Pat. No. 9,598,722 shows an exploded view of a panel consumable. The invention provides panel cartridges comprising several components, including a reaction module (formed by a bottom substrate and a top plate), a liquid reagent module (LRM), and a housing that keeps the components together. The bottom substrate comprises a sample preparation zone, reagent zone, Sample Manipulation Zone, Amplification Zone, Detection Zones as further described in U.S. Patent Publication no. 2015/0323555 and U.S. Pat. No. 9,598,722 which are herein incorporated by reference in their entireties. Specifically, in the embodiments for detecting nucleic acid targets, the substrate comprises one or more amplification pathways/zones. See item 364 in FIGS. 2-4 of U.S. Pat. No. 9,598,722. The top plate is spotted with reagents and primers. See FIG. 5 of U.S. Pat. No. 9,598,722. In a new embodiment, the top plate is coated with a hydrophobic material. The hydrophobic material can act as an electrical insulation, can repel water and oil, can reduce mold release, supports chemical resistance and moisture resistance properties. The hydrophobic material can be CYTOP, parylene or NeverWet. In a preferred embodiment the hydrophobic material is CYTOP. The top plate is coated during the reaction module manufacturing process. The top plate is first cleaned and dried. The top plate is then coated with conductive coating (such as PEDOT or ITO-indium tin oxide) and then with the hydrophobic material. The top plates are then sealed in an air tight bag and are available for adding the assay specific reagents up to days, weeks or even months later. Industrial spray equipment is used to apply the hydrophobic coating.

The LRM includes fluid filled blisters, as generally depicted in FIG. 1 from U.S. Patent publication no. 2014/0194305 which is herein incorporated by reference in its entirety. For example, lysis buffer (which in some cases can be water for hypotonic lysis, or can be a commercially available lysis buffer, such as those containing chiatropic salts such as guanidinium salts, and or high/low pH, and/or surfactants such as sodium dodecyl sulfate (SDS). Polysorbate 20, Triton-X, etc. is contained within a blister that is activated to add lysis buffer to the sample. These buffers and in particular Polysorbate 20 (such as Tween® 20) can be washed or they can remain in the sample upon amplification. The top plate may include a PDOT (or PEDOT) coating (PEDOT:PSS or poly(3,4-ethylenedioxythiophene) polystyrene sulfonate).

As used herein, the term RP Panel means respiratory panel. The RP panel includes all of the oligonucleotides and reagents for carrying out a nucleic acid amplification reaction for the targets listed in Table 1 as well as the capture and signal probes to form the hybridization complex necessary to detect the targets listed in Table 1.

As used herein, the term “RP cartridge” means a cartridge for performing respiratory assays in a closed sample preparation and reaction system as described in U.S. Pat. No. 9,598,722 which is herein incorporated by reference in its entirety.

As used herein, the term BCID-GP means Blood Culture identification-Gram-Positive Panel. The BCID-GP panel includes all of the oligonucleotides and reagents for carrying out a nucleic acid amplification reaction for the targets listed in Table 2 as well as the capture and signal probes to form the hybridization complex necessary to detect the targets listed in Table 2.

As used herein, the term BCID-GN means Blood Culture Identification-Gram-Negative Panel. The BCID-GN panel includes all of the oligonucleotides and reagents for carrying out a nucleic acid amplification reaction for the targets listed in Table 3 as well as the capture and signal probes to form the hybridization complex necessary to detect the targets listed in Table 3.

As used herein, the term BCID-FP means Blood Culture Identification-Fungal Panel. The BCID-FP panel includes all of the oligonucleotides and reagents for carrying out a nucleic acid amplification reaction for the targets listed in Table 4 as well as the capture and signal probes to form the hybridization complex necessary to detect the targets listed in Table 4.

As used herein, the term “BCID-GP cartridge” or “BCID-GN cartridge” or “BCID-FP cartridge” means a cartridge for performing gram-positive, gram-negative, or fungal assays respectively in a closed sample preparation and reaction system as described in U.S. Pat. No. 9,598,722 which is herein incorporated by reference in its entirety.

“Bay” or “cartridge bay” means a processing unit which runs a panel consumable. Bays as used herein are further described in U.S. Patent publication no. 2014-0194305, U.S. Patent Publication no. 2015/0323555 and U.S. Pat. No. 9,598,722 which are herein incorporated by reference in their entireties.

“Instrument” means an instrument configured to process a fluid sample contained in a cartridge. The instrument comprises a number of components, including a central processing unit that allows independent bay controllers and electric and network connections to each tower, an optional identification tag reading device (e.g., a bar code scanner) and a touch screen user interface with individual icons corresponding to each bay. A cartridge is placed into an instrument bay and processed.

As used herein, the term “about” means encompassing plus or minus 10%. Fax example, about 90% refers to a range encompassing between 81% and 99% nucleotides. As used herein, the term “about” is synonymous with the term approximately.

Unless otherwise indicated or the context suggests otherwise, as used herein, “a” or “an” means “at least one” or “one or more.”

The word “or” as used herein means any one member of a particular list and also includes any combination of members of that list.

### DETAILED DESCRIPTION OF THE INVENTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Certain embodiments of the present invention aim to provide a device and/or method which delivers a fluid, gas or solid, in a controlled manner to a target location. It is an aim of certain embodiments of the present invention to provide a film which protects a blister pouch and prevents an undesired breach while at the same time is breakable allowing the blister pouch below to burst when desired and in a controlled way.

Label

The clinical diagnostic instrument as disclosed in U.S. Pat. No. 9,598,722 and U.S. Publication no. 2014-0194305 which are herein incorporated by reference in their entirety is designed to accept and process a cartridge also described in U.S. Pat. No. 9,598,722 and U.S. Publication no. 2014-0194305. Specifically, as shown in FIG. 4 of U.S. Pat. No. 9,598,722 an upper shroud (also referred to herein as an external housing) 12 is disposed over a top portion of the sample preparation module 70 and includes openings corresponding in number, size, and shape to the various deformable compartments (blisters) supported on the sample preparation module 70. As can be appreciated from FIG. 1 of U.S. Pat. No. 9,598,722, the deformable compartments (blisters) are recessed within the openings formed in the upper shroud 12, thereby providing some protection for the deformable compartments while allowing each compartment to be compressed from above by an actuator.

As shown in FIG. 8A of U.S. Publication no. 2014-0194305, a fluid vessel (or blister) 122 is mounted on a substrate 124 and is connected by means of a channel 130 to a sphere blister 128. In certain embodiments, channel 130 may be initially blocked by a breakable seal. A film layer 129 may be disposed on the bottom of the substrate 124 to cover one or more channels formed in the bottom of the substrate 124 to form fluid conduits. An opening device, comprising a sphere 126 (e.g. a ball bearing) is enclosed within the sphere blister 128 and is supported, as shown in FIG. 8A of U.S. Publication no. 2014-0194305, within the sphere blister 128 by a foil partition or septum 125. The foil partition 125 prevents fluid from flowing from the vessel 122 through a recess 127 and fluid exit port 123. Upon applying downward force to the sphere 126, however, a large local compressive stress is generated due to the relatively small surface size of the sphere 126, and the foil partition 125 can be broken with relatively little force to push the sphere 126 through the partition 125 and into the recess 127, as shown in FIG. 8B of U.S. Publication no. 2014-0194305. With the foil partition 125 broken, a relatively small additional force is required to break a seal within channel 130 and force the fluid to flow from the vessel 122 through the fluid exit port 123. An actuator mechanism for compressing deformable fluid vessels such as blisters on a liquid reagent module embodying aspects of the present invention is shown at reference number 50 in FIG. 2 of U.S. Publication no. 2014-0194305.

This application adds a label over the cartridge described in U.S. Pat. No. 9,598,722 and U.S. Publication no. 2014-0194305. The label design is unique in that it must be puncture-able (compressible) over the blister so that the blister compression mechanism described in U.S. Publication no. 2014-0194305 can compress the blister (1) to push the sphere through the blister and (2) allow fluid to flow from the blister to the liquid regent module or reaction module. The label must be designed so that when it is compressed it does not lift off from the external housing and attach to the compression mechanism or otherwise jam the instrument. In the present embodiment (chads formed by a serpentine or spiral separation line), less than 0.5% of chads release into the instrument.

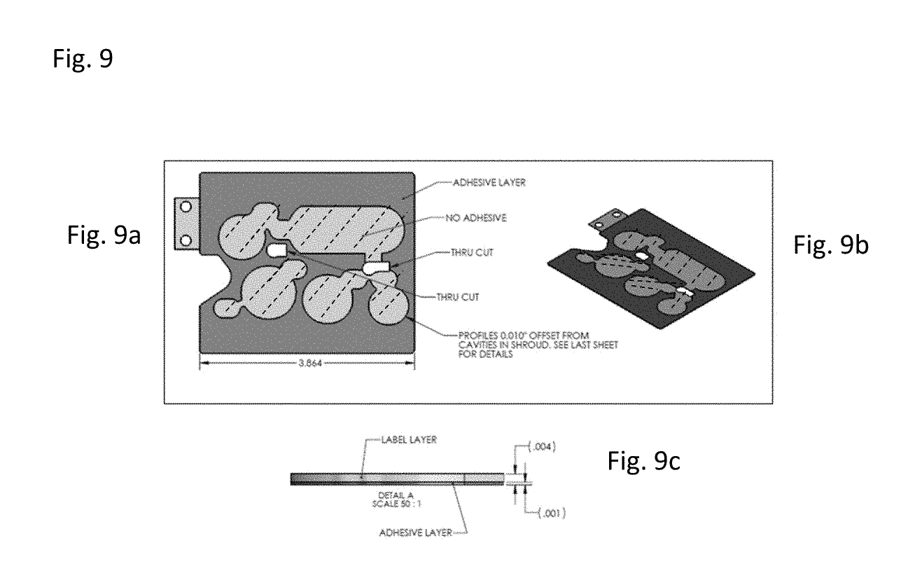

The label in accordance with the invention includes a sheet-like member having an upper surface (in FIG. 9 called the label layer) and an adhesive lower surface (in FIG. 9 called the adhesive layer). In FIG. 9, the dark gray region has an adhesive and the light gray region does not have an adhesive. The upper surface is capable of displaying information-conveying indicia thereon such as a patient's name, a patient's social security number, a patient's account number, patient vital statistics, cartridge identification, cartridge identification code, a bar code, pharmaceutical drug names, drug dosage information, as well as other patient information, words, symbols or alphanumeric text. The indicia preferably may be printed by human or mechanical means. For example, a health care provider may apply a sticker with information printed on the sticker and apply the sticker to the label. The health care provider may also use a pen or pencil to write information on the label alone or in addition to indicia printed on a sticker and applied to the label.

As described in more detail below, the upper surface has perforations. Stated another way the label has a separable component. The perforations are useful for pushing an external compression mechanism (such as a compressor or finger) through the label to a compressible blister below. Because the label surface is flush/even/level across the cartridge, the entire surface of the label can be printed upon.

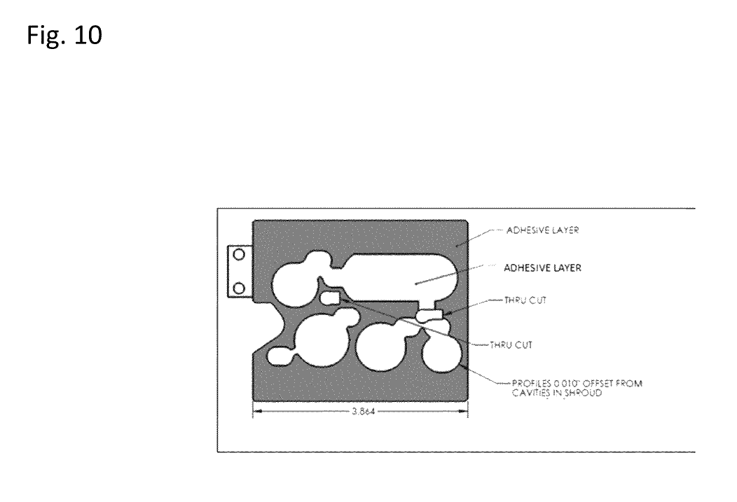

In one embodiment, the lower surface of the label is adhesive. See FIGS. 9 and 10. The adhesive on the lower surface may be a pressure sensitive adhesive, a permanent adhesive, or any other suitable adhesive for adhering the label to the surface of a device during use. In one embodiment, a portion of the label is adhesive and a portion of the label is not. See FIG. 9. In one embodiment, the region of the label over the blister is not adhesive. See FIG. 9. In one embodiment, the region of the label over the blister is adhesive. See FIG. 10.

The chad is designed to fit over a compressible blister. The chad may be the same size as the circumference of the blister or may be slightly larger, i.e., about 1-15% larger. Alternatively, the chad may be slightly smaller than the circumference of the blister, i.e., about 1-15% smaller. The chads may all be the same size or the chads may have a plurality of sizes meaning if the blisters are smaller the chad is smaller and likewise if the blister is larger the chad is larger. Also, some chads on a label may be larger than the blister while others are smaller than the blister. Selecting the size of the chad is within the skill of the artisan. The size of the chad is driven by the tolerances in the manufacturing capabilities of the instrument and cartridge. Prior to using the cartridge, the chad does not touch the blister, i.e., there is an interstitial space between the top of the blister and the bottom of the label. In other embodiments, prior to using the cartridge, the chad touches the blister. After the compression mechanism has pressed on the chad, the chad becomes a hanging chad, i.e., it separates from but does not detach from the rest of the label, in some embodiments the hanging chad is connected via one side and in others it is connected by more than one side. In other embodiments the chad separates from the label and there is a collector to collect the chad so that it does not gum up the compression mechanism or other instrument mechanisms used to process the cartridge. In a preferred embodiment, the compression mechanism is external to the cartridge.

The chad is designed to be compressed by a compressor. The chad may be the same size as the circumference of the compressor or may be slightly larger, i.e., about 1-15% larger. Alternatively, the chad may be slightly smaller than the circumference of the compressor, i.e., about 1-15% smaller.

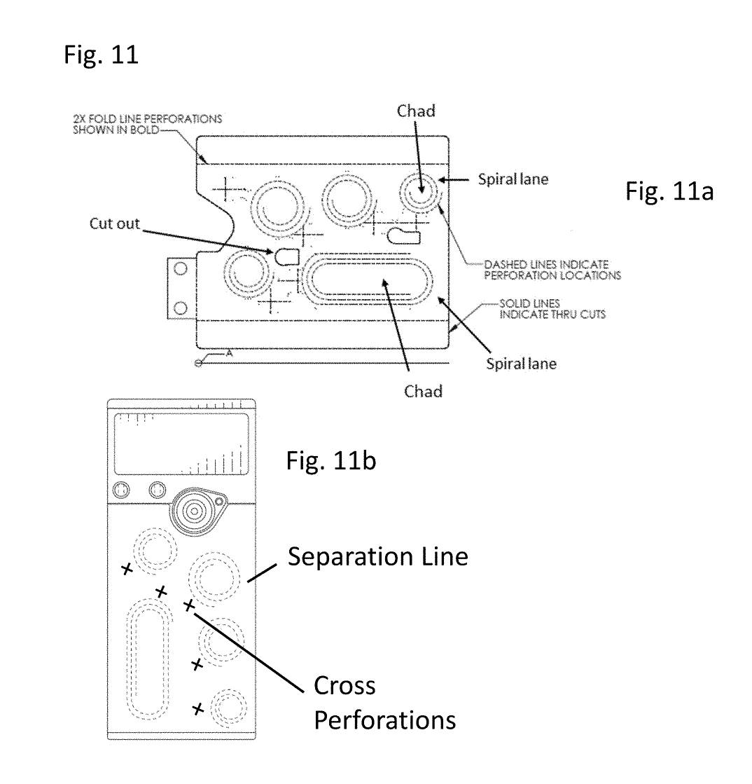

In some embodiments, after compressing the blister, the hanging chad does not touch the blister. In other embodiments, after compressing the blister, the hanging chad touches the blister. The hanging chad should not release (can separate but not detach) from the label surface. If the chad separates but does not detach from the label surface the cartridge remains useable. The chad is formed by a separation line that may be a cut in the label surface or perforations in the label surface. The separation line (See FIG. 11b) is called a spiral lane in FIG. 11a and may also be a combination of cuts and perforations in the label surface, wherein groups of perforations are separated from each other along the separation line by cuts. The chad separation line may be at least partially spiral or serpentine in shape. FIG. 11b also shows the cross cuts which can be perforations or through cuts.

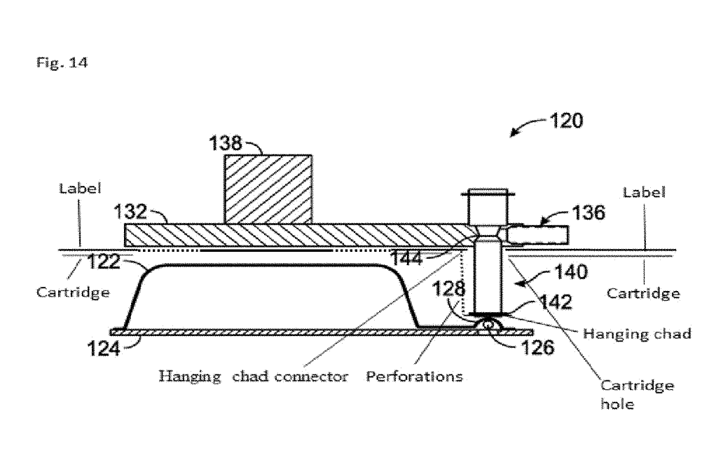

The chad separation line forms an improved chad having an accordion-like structure. The separation line may alternatively have at least partially a zig-zag (i.e., sawtooth) pattern. The specific shape or pattern of the separation line is not important. It is merely preferable that the separation line forms a chad such that at least part of the chad remains in contact with the label surface so that the chad does not separate/detach from the label. This connection between the hanging chad and the rest of the label is called the hanging chad connector. See FIG. 14. The hanging chad connector ensures that the last connection to the label need not be pulled to break the chad from the label causing tearing in the label. The area of the label surface traversed by the separation line forms a chad on the label surface. In other words, the chad is generally an area bounded by the separation line. For example, if the separation line is elliptical in shape, the chad portion is bounded by the major and minor axes of the ellipse. The shape of the separation line and in film the amount of area of the chad determines the size of the hanging chad. The specific disposition of the chad/separation lines on the label, is not fixed to any particular location, except that they should be over or partially over a compressible element.

The chad is connected to the label via the hanging chad connector in a non-releasable/non-detachable manner but is separable from the label surface. The chad includes perforations which allow the chad to separate from the label surface but not detach. Stated another way, the chad is separable from the label surface along the separation line also called a perforation line. The area separable from the label surface is a hanging chad. The hanging chad can have an adhesive surface so that it sticks to the blister when it is compressed down by the compression mechanism. In this way, even if the chad were to detach from the label it would not be free floating in the instrument and potentially interfere with the instrument's operations.

Each chad can be independently separable from the label surface or they may he separated at the same time. When each chad is independently separable from the label the same compressor can be used to compress each chad or different compressors can be used. When each chad is separated from the label at the same time the same compressor can be used to compress each chad or different compressors can be used. In some embodiments the shape of the compressor conforms to the shape of the chad and/or compressible element, in other embodiments it is different.

The perforation/separation line can take on many shapes as determined by a skilled artisan such as square, rectangle, oval, triangular, serpentine, spiral, accordion, etc. The perforation line can also be said to be a winding path of perforations. In any event, the separation line should not allow the chad to break away from the rest of the label. In a preferred embodiment the separation line has a start and end that creates a hanging chad. In a preferred embodiment the separation line has a start and end at different locations. Stated another way, the separation line has a first end and a second end. In a preferred embodiment the start end of the separation line forms the hanging chad connector.

In a preferred embodiment, the perforation line conforms to the shape of the compressible element, the shape of the compressor or both. The perforation lines generally do not overlap. Although, as can be appreciated by a skilled artisan, the perforation lines can overlap one another. The ties between the perforations are between approximately 0.001 inches and 0.1 inches apart, preferably 0,005 inches to 0.025 inches apart preferably 0.012 inches apart. The perforations (cuts) are between 0.150 inches to 0.5 inches wide preferably 0.339 inches wide. In a preferred embodiment, perforations are 2.85 ties per inch with 0.012 inches per tie. The cuts need not be uniform in size. The ties need not be uniform size.

The forced needed to compress a chad which does not have a serpentine separation line but instead is a closed circular shape as in the prior art is greater than 3 lbs likely between 3-6 lbs vertical force. Much less force: less than 3 lbs of vertical force (less than 10 N) and preferably about 0.25 lbs of vertical force i.e., negligible force is needed to compress a chad with a serpentine separation line. Embodiments contemplate a label wherein the chad separates but does not detach from the rest of the label with 0.01-3 lbs (1-11 N) of compressive vertical force, preferably 0.2-0.5 lbs compressive vertical force, or preferably 0.25 lbs compressible vertical force. Embodiments contemplate a label wherein the chad separates but does not detach from the rest of the label with less than 3 lbs (less than 10 N) of compressive vertical force, preferably 3 lbs (10N) of compressive vertical force, preferably less than 1 lbs compressive vertical force, or preferably less than 0.3 lbs compressible vertical force. Embodiments contemplate a label wherein the chad separates but does not detach from the rest of the label over each compressible element regardless of size with less than 3 lbs (less than 11 N) of compressive vertical force.

Because the vertical compressive force to separate the chad formed by a serpentine separation line is negligible, routine handling can cause the chad to begin separation prior to pulling the cartridge into a bay/instrument. In some embodiments, even when the chad has partially separated from the rest of the label, the cartridge is still usable. In some embodiments, even when the chad has fully separated from the rest of the label, the cartridge is still usable.

Identifying information such a lot number, cartridge type, manufacturer and patient identification name, can be printed within the Chad so that it is not destroyed upon separation of the chad from the label. Alternatively identifying information can cross the separation lines and is destroyed when the chad separates from the label.

In prior art embodiments, when compressing a fluid vessel, or blister, to displace the fluid contents thereof, sufficient compressive force must be applied to the blister to break, or otherwise open, a breakable seal that is holding the fluid within the vessel. The amount of force required to break the seal and displace the fluid contents of a vessel typically increases as the volume of the vessel increases. This is illustrated in the bar graph shown in FIG. 11 of U.S. Pat. No. 9,453,613, which shows the minimum, maximum, and average blister burst forces required for blisters having volumes of 100, 200, 400, and 3000 microliters. The average force required to burst a blister of 400 or less microliters is relatively small, ranging from an average of 10.7 lbs to 11.5 lbs. On the other hand, the force required to burst a blister of 3000 microliters is substantially larger, with an average burst force of 43.4 lbs and a maximum required burst force of greater than 65 lbs. Generating such large forces can be difficult, especially in low profile actuator mechanisms, such as those described above and in U.S. Pat. No. 9,453,613, in which horizontal displacement of an actuator is converted into vertical, blister-compressing movement of a platen.

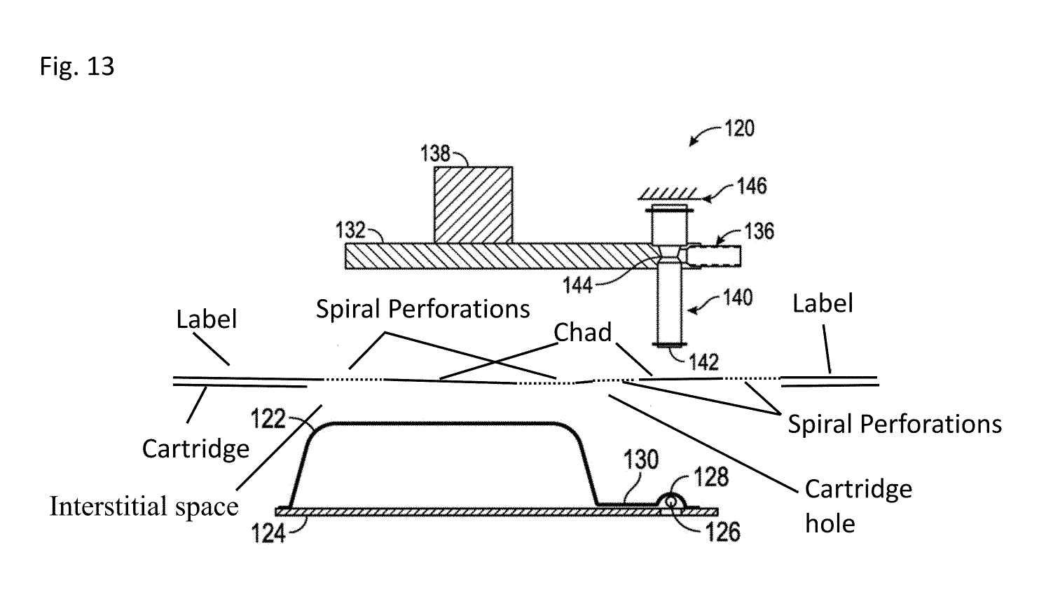

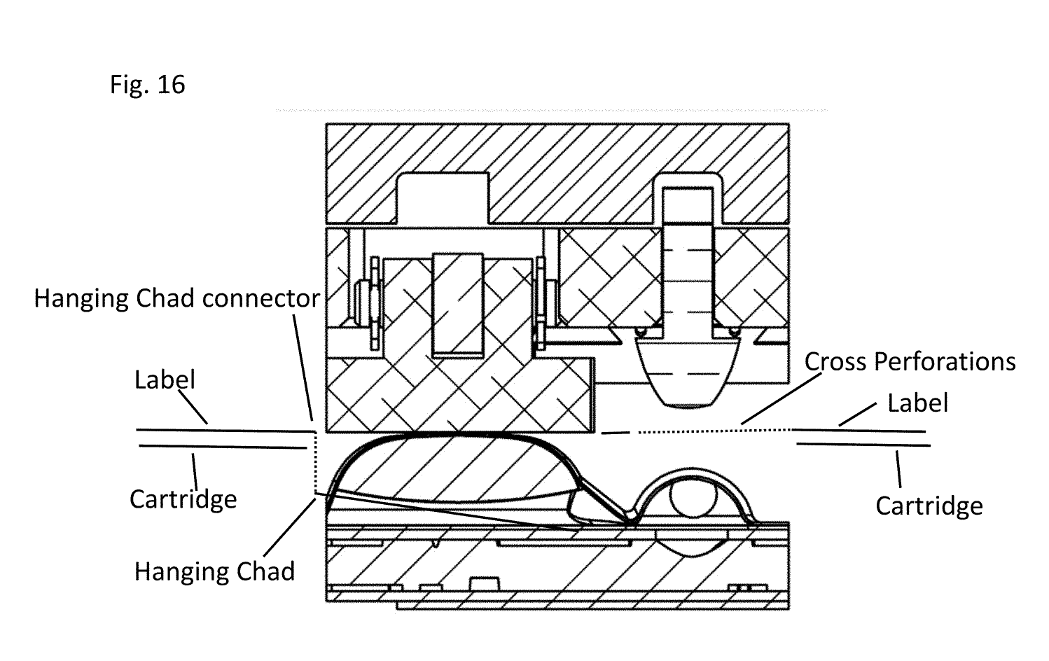

Accordingly, aspects of the embodiments described herein are methods and apparatus for opening a fluid vessel, or blister, in a manner that reduces the amount of force required to burst the vessel and displace the fluid contents of the vessel. A label with a chad formed by a serpentine separation line allows for significantly less force to be applied to the label to separate the label and compress the blister below. Accordingly, aspects of the embodiments described herein include the combination of a first chad over a fluid filled blister formed by a serpentine separation line and cross perforations over a ball bearing blister (sphere blister). In some embodiments, the serpentine separation line and cross perforations touch and in others they do not touch. See FIGS. 13-16. As can be seen in FIGS. 13 and 14 it is also possible to have the perforations above the sphere blister form a spiral lane and hanging chad.

Because the force needed to break open a sphere blister is low, it is desirable to require little (less than 3 lbs of vertical force) to break open a fluid filled blister so that the same motors/compressors/actuators could be used to open both the sphere blister and fluid filled blister. As such, there was a need to create a label which could be compressed with less than 3 lbs of vertical force. This low force requirement allows the assay to be opened in an instrument/bay with low profile actuator mechanisms.

Prior art embodiments having a chad formed by closed circular perforations do not allow for shift during label application or cartridge shift within the detection instrument (i.e., within the bay). Designing for manufacturing tolerances helps reduce costs and ensures less manufacturing waste. Labels having a chad formed by a serpentine separation line allow for shift of 0-10 mm within the instrument bay, preferably 1-5 mm shift within the bay. Labels having a chad formed by a serpentine separation line allow for 0-10 mm of shift in the label application, preferably 1-5 mm shift in the label application.

Prior art embodiments having a chad formed by closed circular perforations tend to pull up on the compressor foot. See Example 2 which shows that no cartridges with chads formed by closed circular perforations were run successfully. Because label chads formed by a serpentine separation line break apart as coils, they do not pull hard at the last connection to the label resulting in less tearing; less force is required to separate the chad from the label and less inadvertent “pull” up on the compressor foot.

Perforations and ties for the cross cuts and serpentine separation lines are approximately the same size and are within the same range. The maximum size for a compressible element to be compressed with a cross cut in the label and not tear the label is 0.1-0.8 inches wide preferably 0.4 inches. Reagent filled blisters tend to range in length from 0.4 inches to 6 inches. The oil blister, being just over 2 inches long.

As can be seen from FIG. 14, the hanging chad is connected to the label surface at one end of the spiral channel also called the spiral lane, like a flap on a box. In other embodiments, not shown, the hanging chad can be connected to the label surface at two ends of the spiral channel also called the spiral lane. In either case, the part that connects the hanging chad to the label is called a hanging chad connector.

In preferred embodiments, patient identifying information is printed across the perforation so that when the chad is compressed and the hanging chad (as well as the serpentine channel or spiral lane) hangs down, patient identifying information is “cut through” or otherwise destroyed. In this way, the perforations aid a health care provider/laboratory by allowing the provider to easily destroy the patient information displayed on the label by simply using the cartridge—no additional steps are needed to destroy the patient identifying information.

In preferred embodiments, a machine readable identification code is printed across the perforation so that when the chad is compressed and the hanging chad (as well as the separation line) hangs down, the machine readable identification code is “cut through” or otherwise destroyed or otherwise rendered unreadable. When the machine readable identification code is rendered unreadable, the cartridge is prevented from being re-used. Stated another way when the hanging chad is formed, the label's identification code becomes unreadable, thereby preventing reuse of the cartridge. Forming the hanging chad should prevent reuse of the cartridge.

A compression mechanism having a tack-less surface releasablely contacts with the chad portion of the label. The compression mechanism surface may be siliconized (i.e., may have a layer of silicone material thereon). Alternatively, the chad may be coated with a material similar to a silicone material that renders the upper surface of the chad tackless. By having a tackless surface, the compression mechanism is easily separable from the label surface when it is desired to separate the two. The chad, however, has sufficient connections to the label surface that the two remain in contact following compression by the compression mechanism.

The hanging chad is separable from the label surface along the separation line (also called the serpentine channel or spiral lane).

If the label surface is considered to lie in a single plane, the separation lines would generally not be above or below the label surface.

Additionally or alternatively, the label may include at least one side surface. In this way additional information, for instance identifying the manufacturer of the product contained on the cartridge may be displayed.

In certain embodiments, the cartridge includes a compressible element housing a dosage of medicine. The dosage can contain two or more separated components each component in a different compressible pouch. After the compression mechanism compresses a first pouch and a second pouch, the contents mix. Mixing can occur outside the cartridge, i.e., the components are both expelled from the cartridge and mixed in a new container. Mixing can occur in a cartridge sub-assembly, i.e., the components are expelled into a second region of the cartridge where they are mixed or further processed. Mixing can occur within the LRM, i.e., the components can mix in one of the two compressible pouches they were stored in or the components can mix in a third pouch called a mixing pouch (or dispensing pouch) and then the dispensing pouch is compressed to expel the combined components. In this way the cartridge is an appropriate dispensing device to deliver doses of a pharmaceutical agent or mixture comprising one or more pharmaceutical agents. The above can also be applied to food.

In an alternative embodiments an identification code (such as patient information or cartridge information in the form of alphanumeric code, bar code or QR code) is printed directly onto the blister and the label has holes over the portion of the blister covering the blister, i.e., a chad-less label. In this way, when the blister is compressed, the identification code is deformed and/or destroyed preventing re-use of the cartridge. Envisioned is a disposable fluidic cartridge comprising: a body having a recess therein and a compressible element disposed within the recess; and further comprising: a machine-readable identification code on the compressible element, configured to be compressed upon insertion of a mechanical actuator into the recess to actuate the compressible element, thereby rendering the identification code unreadable and preventing reuse of the cartridge. Envisioned is a method of using a disposable fluidic cartridge having a recess, a compressible element disposed within the recess, and an identification code on the compressible element the method comprising: receiving inserting the disposable cartridge within a cartridge reader; attempting to detect an identification code on the compressible element; and, if successful, upon successfully detecting the identification code, extending a mechanical actuator into the recess on the disposable cartridge to compress the compressible element thereby rendering the identification code unreadable.

Compressor

One or more compressors are positioned relative to the cartridge and configured to press on a label chad to selectively disturb it such that the chad is separated from the label surface and becomes a hanging chad. In this way the label gives the compressor access to a compressible element below the label.

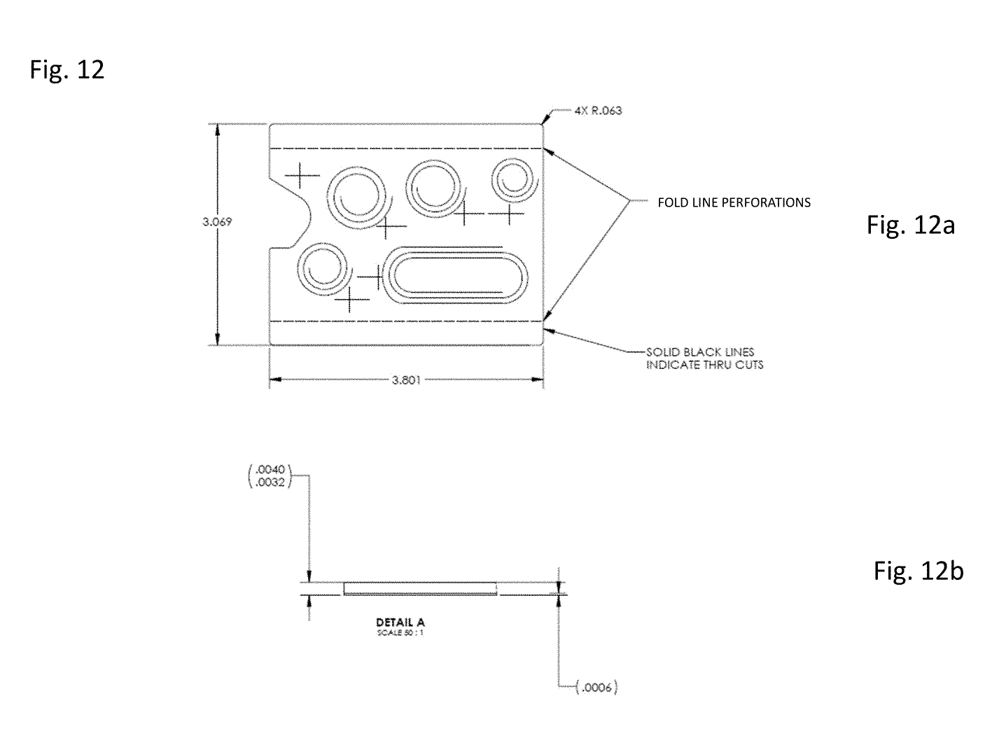

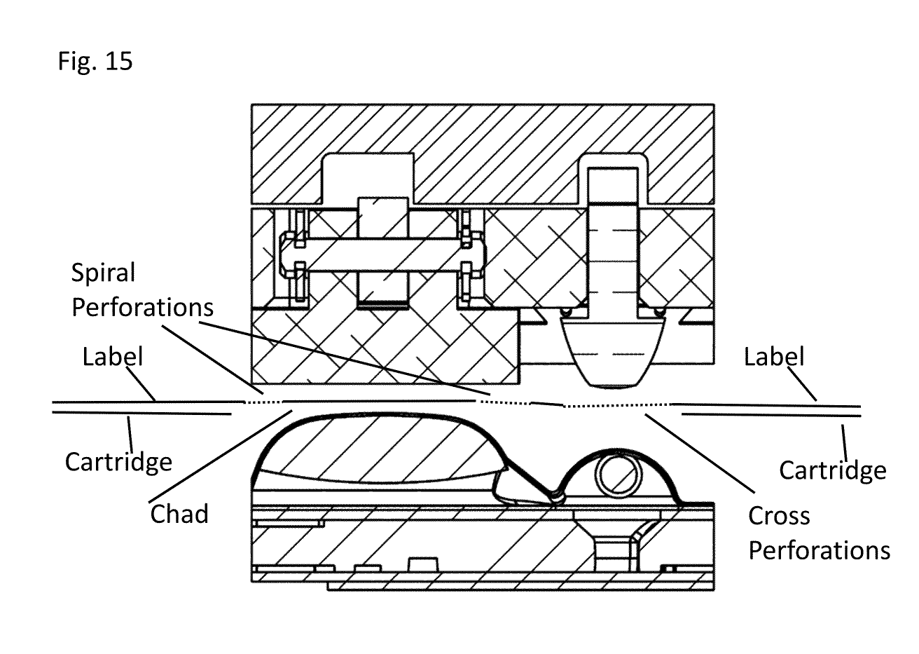

In one embodiment, the region on the label defining the circumference of the blister is perforated in a serpentine pattern. In one embodiment, the region on the label over the blister is perforated in a cross pattern (also called cross hairs). In one embodiment, the region on the label over a plurality of blisters is perforated in a serpentine pattern and the region on the label over a plurality of blisters is perforated in a cross pattern. In one embodiment, the area on the label within the circumference of the serpentine pattern is not adhesive. In one embodiment, the area on the label within the perimeter of the cross pattern is not adhesive. As see in FIG. 11 the serpentine and cross perforations can be seen as dashed lines. In one embodiment, the label further has one or more regions which are cut through. FIGS. 10 and 11. In one embodiment, the serpentine perforation defining the circumference of the blister is cut through. In one embodiment, the cross perforation over the blister is cut through. In one embodiment, the area defining the circumference of a plurality of blisters is perforated in a serpentine pattern and the area defining the circumference of a plurality of blisters is perforated in a cross patient In preferred embodiments, the area defining the circumference of a fluid filled blister is perforated in a spiral or serpentine pattern and the area defining the circumference of a sphere blisters is perforated in a cross pattern. Stated another way, fluid filled blisters have chads above them formed by a spiral/serpentine separation line while sphere blisters have a label above which is formed by a cross cut in the label. If the larger fluid filed blisters had cross cuts or one or more lines crossing the sphere blister (as in the prior art), the label would tear causing uneven compression and uneven fluid flow from the blister. As see in FIG. 12 the serpentine and cross perforations can be seen as dashed lines. As can be seen from FIGS. 13 and 15 the blister appears to be in a recess formed by the housing and the label covers the housing. In some embodiments the label covers only a portion of the hole in the housing/compressible element. Unlike prior art disclosures, the chad is compressed and separates but does not detach from the label by a compression mechanism above. No mechanically-actuated mechanism is needed below the label to facilitate breaking the label. The serpentine separation line removes the need to have a mechanically-actuated mechanism below the label to break the label.

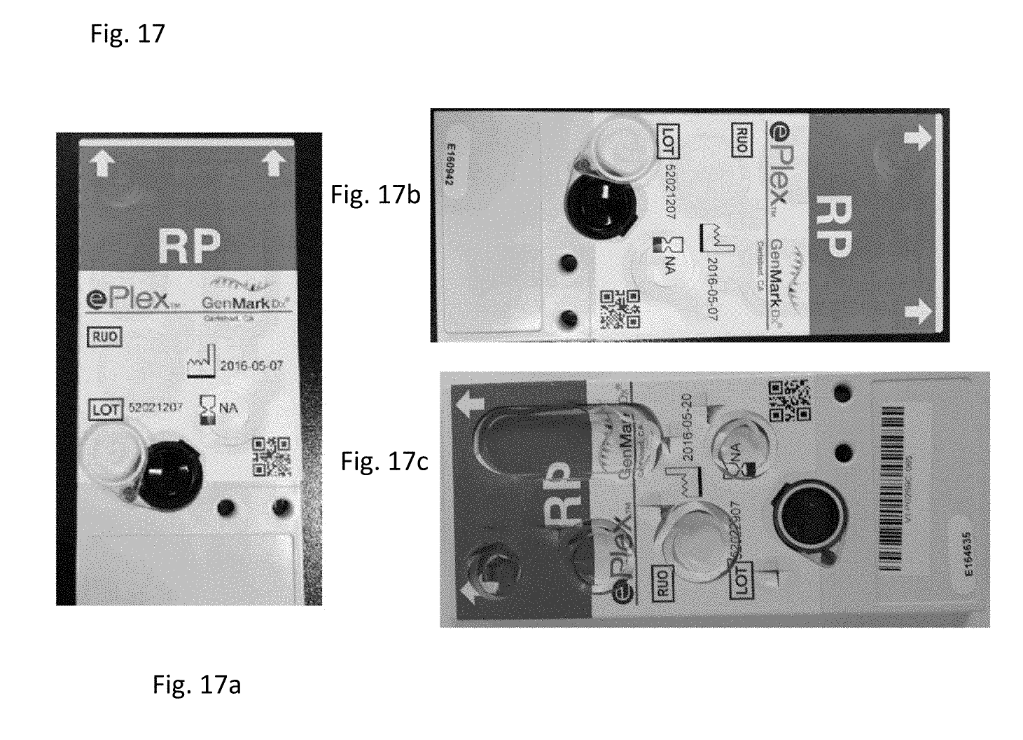

FIGS. 17a and b show a cartridge which has not yet been used. The blisters are recessed within an external housing (not flush with the external housing) and the external housing has openings where the blisters are. The label is flat over the blister and external housing. FIG. 17c shows a cartridge which has been used and, as can be seen, the serpentine perforations have been depressed down in toward the blister below the plane of the external housing. Further, a sphere can be pushed out of a blister by applying a compressive force through the label and onto the compressible element housing the sphere. As can be seen from FIG. 17c, the cross perforations have been depressed down in toward the blister to expel a sphere out of the blister below the plane of the external housing.

The compressor and actuator element can be further understood by reference to U.S. Pat. No. 9,453,613 and U.S. Publication no. 2014-0194305 which are herein incorporated by reference in their entirety.

Specifically, U.S. Publication no. 2014-0194305 shows an apparatus in FIGS. 9A, 9B, 9C, 9D for opening a vessel by pushing a sphere 126 through foil partition 125. In that illustrated embodiment, the apparatus 120 includes a ball actuator 140 extending through an opening formed through a blister plate, or platen, 132. With the blister plate 132 and an actuator 138 configured for moving the blister plate 132 disposed above the vessel 122, the ball actuator 140 is secured in a first position, shown in FIG. 9A of U.S. Publication no. 2014-0194305, by a detent 136 that engages a detent collar 144 formed in the ball actuator 140.

As shown in FIG. 9B of U.S. Publication no. 2014-0194305, the blister plate 132 is moved by the actuator 138 down to a position in which a contact end 142 of the ball actuator 140 contacts the top of the of the sphere blister 128. Actuator 138 may comprise a low profile actuator, such as actuator mechanisms 50 or 80 described in U.S. Publication no. 2014-0194305.

As shown in FIG. 13 of this application, the compressor's contact end 142 contacts the label and pushes on the label separating the chat from the rest of the label via serpentine perforations in the label which allow the label to separate from but not detach from the rest of the label See FIG. 14.

The label can further be understood by the following numbered paragraphs

Paragraph 1: A biochip cartridge for detecting a target analyte, the biochip cartridge comprising: A) a reaction module; B) a liquid reagent module (LRM) comprising a plurality of blisters; C) an external housing having open areas over at least one of the plurality of blisters; and D) a label affixed to the external housing and over at least one of the open areas.

Paragraph 2: A cartridge comprising: A) a liquid reagent module (LRM) comprising a plurality of blisters; B) an external housing having open areas over at least one of the plurality of blisters; and C) a label affixed to the external housing and over at least one of the plurality of blisters.

Paragraph 3: A cartridge according to any preceding Paragraph, wherein the label over at least one of the plurality of blisters is perforated.

Paragraph 4: A cartridge according to any preceding Paragraph, wherein the label over at least one of the plurality of blisters is perforated in a serpentine configuration.

Paragraph 5: A cartridge according to any preceding Paragraph, wherein the label over at least one of the plurality of blisters is perforated in a serpentine pattern.

Paragraph 6: A cartridge according to any preceding Paragraph, wherein the label over at least one of the plurality of blisters is perforated in a cross configuration.

Paragraph 7: A cartridge according to any preceding Paragraph, wherein at least one of the plurality of blisters is a fluid filled blister and the label over the blister is perforated.

Paragraph 8: A cartridge according to any preceding Paragraph, wherein at least one of the plurality of blisters is filled with a solid and the label over the blister is perforated.

Paragraph 9: A cartridge according to any preceding Paragraph, wherein at least one of the plurality of blisters is a first blister and the label over the first blister is perforated.

Paragraph 10: A cartridge according to any preceding Paragraph, wherein at least one of the plurality of blisters is a second blister and the label over the second blister is perforated.

Paragraph 11: A cartridge according to any preceding Paragraph, wherein at least one of the plurality of blisters is a first blister and a second blister and the label over the first blister and second blister is perforated.

Paragraph 12: A cartridge according to any preceding Paragraph, wherein at least one of the plurality of blisters is a first blister and a second blister and the label over the first blister is perforated in a cross configuration and the label over the second blister is perforated in a serpentine configuration.

Paragraph 13: A cartridge according to any preceding Paragraph, wherein at least one of the plurality of blisters is a fluid filled blister and at least one of the plurality of blisters is filled with a solid and the label over the fluid filled blister and solid filled blister is perforated.

Paragraph 14: A cartridge according to any preceding Paragraph, wherein the at least one of the plurality of blisters is a fluid filled blister and a solid filled blister and the label over the fluid filled blister is perforated in a serpentine configuration and the label over the solid filled blister is perforated in a cross configuration.

Paragraph 15: A cartridge according to any preceding Paragraph, wherein the label is adhesive.

Paragraph 16: A cartridge according to any preceding Paragraph, wherein the label over the at least one of the plurality of blisters is not adhesive.

Paragraph 17: A cartridge according to any preceding Paragraph, wherein the label over the at least one of the plurality of blisters is perforated and not adhesive.

Paragraph 18: A cartridge according to any preceding Paragraph, wherein the label over at least a portion of the external housing is cut out.

Paragraph 19: A cartridge according to any preceding Paragraph, wherein the label over at least one of the plurality of blisters is perforated and not adhesive, and the label over at least a portion of the external housing is cut out.

Paragraph 20: A cartridge according to any preceding Paragraph, wherein the label over at least one of the plurality of blisters does not adhere to a compression mechanism after the compression mechanism expels a fluid from the blister.

Paragraph 21: A cartridge according to any preceding Paragraph, wherein the label over at least one of the plurality of blisters does not adhere to a compression mechanism after the compression mechanism expels a solid from the blister.

Paragraph 22: A cartridge according to any preceding Paragraph, wherein the label after the compression mechanism expels the fluid from the blister remains attached to the hanging chad.

Paragraph 23: A method for displacing fluid from a fluid container comprising applying a compressive force through a label to a blister comprising an opening element thereby pushing the opening element through a sealing partition and permitting fluid flow from the fluid container.

Paragraph 24: A method for displacing fluid from a fluid container comprising applying a compressive force through a label to a blister thereby pushing fluid within the blister to flow from the fluid container.

Paragraph 25: A method for displacing fluid from a fluid container comprising applying a first compressive force through a label to an opening element thereby pushing the spherical opening element through a sealing partition and applying a second compressive force through a label to a fluid filled blister thereby pushing fluid within the blister to flow from the fluid container.

Paragraph 26: A label having a serpentine perforation forming a hanging chad when the serpentine perforation is compressed.

Paragraph 27: The label of any preceding paragraph wherein the label is adhesive.

Paragraph 27: The label of any preceding paragraph wherein the label is not adhesive under the serpentine perforation.

Paragraph 28: The label of any preceding paragraph wherein the serpentine perforation forms a serpentine cap.

Paragraph 29: The label of any preceding paragraph wherein the serpentine perforation forms a serpentine lane.

Paragraph 30: The label of any preceding paragraph wherein the serpentine lane circumscribes the serpentine cap 1-3 times.

Paragraph 31: The label of any preceding paragraph wherein serpentine lane 1 is adhesive and serpentine lanes 2 and 3 are non-adhesive.

Paragraph 32: The label of any preceding paragraph wherein serpentine lanes one and two are adhesive and serpentine lane 3 is non-adhesive.

Paragraph 33: A label having a cross perforation.

Paragraph 27: The label of any preceding paragraph wherein the label is adhesive.

Paragraph 34: The label of any preceding paragraph wherein the label is not adhesive under the cross perforation.

Paragraph 35: A label having a serpentine perforation and a cross perforation.

Paragraph 27: The label of any preceding paragraph wherein the label is adhesive.

Paragraph 36: The label of any preceding paragraph wherein the label is not adhesive under the serpentine perforation and the cross perforation.

Paragraph 37: The label of any preceding paragraph wherein the label is not adhesive under the serpentine perforation the cross perforation and a region connecting the serpentine perforation and the cross perforation.

Paragraph 38: The label of any preceding paragraph wherein the label is not adhesive under the serpentine perforation and the cross perforation and wherein the label is cut out adjacent the cross perforation.

Paragraph 39: The label of any preceding paragraph wherein the serpentine perforation and the cross perforation are connected.

Paragraph 40: The label of any preceding paragraph wherein the serpentine perforation and the cross perforation are not connected.

Paragraph 41: An instrument for processing a cartridge comprising a compressor capable of compressing a label and a compressible pouch.

Paragraph 42: The label of any preceding paragraph wherein the compressive element is fluid filled under the serpentine perforation and the compressive element is filled with a solid under the cross perforation.

RP Panel

The Respiratory Pathogen (RP) Panel is a qualitative nucleic acid multiplex in vitro diagnostic test intended for use on a processing unit for simultaneous detection and identification of respiratory bacterial and viral nucleic acids in nasopharyngeal swabs (NPS) obtained from individuals exhibiting signs and symptoms of respiratory tract infection. The RP Panel is performed directly on NPS samples placed in Viral Transport Media (VTM) in a sample delivery device.

The following bacterial and viral organisms are identified using the RP Panel:

TABLE 1
List of Analytes of the RP Panel

| | |
|---|---|
| Influenza A | Adenovirus |
| Influenza A H1 subtype | Human Metapneumovirus |
| Influenza A H3 subtype | Human Rhinovirus/Enterovirus |
| Influenza A 2009 H1N1 subtype | Coronavirus 229E |
| Influenza B | Coronavirus HKU1 |
| Respiratory Syncytial Virus A | Coronavirus NL63 |
| Respiratory Syncytial Virus B | Coronavirus OC43 |
| Parainfluenza Virus 1 | Bordetella pertussis |
| Parainfluenza Virus 2 | Chlamydophila pneumoniae |
| Parainfluenza Virus 3 | Mycoplasma pneumoniae |
| Parainfluenza Virus 4 | |

Additionally it is contemplated that lower respiratory pathogens could be detected using the systems, methods and devices disclosed herein. The following bacterial organisms are lower respiratory pathogens compatible with the systems methods and devices disclosed herein: Rotavirus A, Sapovirus, Campylobacter lari, Campylobacter upsaliensis, Entamoeba histolytica, Norovirus gII.4, PAN Norovirus gII, Vibrio cholera, Adenovirus 40/41, Aeromonas, Astrovirus 1-8, Escherichia coli O157, Norovirus gI, Clostridium difficile, Clostridium difficile, Shigella/EIEC, Giardia, Campylobacter coli, Escherichia coli (EHEC), Escherichia coli (EPEC), Escherichia coli (STEC), Rotavirus A, Clostridium difficile, Cryptosporidium, Dientamoeba fragilis, Escherichia coli (ETEC), Plesiomonas shigelloides, Adenovirus (PAN), Cyclospora cayetanensis, Salmonella and Vibrio cholera.

Gram-Positive Panel

The Gram-Positive (BCID-GP) Panel is a fully automated, qualitative, nucleic acid, multiplex in vitro diagnostic test for the simultaneous qualitative detection and identification of multiple potentially pathogenic gram-positive bacterial organisms and select determinants of antimicrobial resistance in positive blood culture. In addition, the BCID-GP Panel also detects but does not differentiate Gram-Negative bacteria (Pan Gram-Negative assay giving a gram-negative call) and several Candida species (Pan Candida assay giving a Candida call) present in co-infections. The BCID-GP Panel is performed directly on blood culture samples identified as positive by a continuously monitoring blood culture system that demonstrate the presence of organisms as determined by Gram stain.

The BCID-GP Panel contains assays for the detection of genetic determinants of resistance to methicillin (mecA and mecC) and vancomycin (vanA and vanB) to aid in the identification of potentially antimicrobial resistant organisms in positive blood culture samples. The antimicrobial resistance gene detected may or may not be associated with the agent responsible for the disease.

The BCID-GP Panel also contains targets designed to detect a broad range of organisms with a potentially misleading Gram stain result or organisms that may be missed by Gram staining altogether for example in the case of co-infections. These include a broad Pan Gram-Negative assay as well as a Pan Candida assay, both of which may provide data to facilitate the correct testing algorithm. As such, the present disclosure relates to methods and systems for a) distinguishing between contamination and gram-positive bacterial infection, b) distinguishing between gram-positive bacterial species infection; c) distinguishing between some gram-positive bacterial species and some gram-positive genus infection(s); d) identifying but not differentiating gram-negative bacterial infection and fungal infection. The present disclosure further relates to methods and systems for identifying a pathogen that is likely a contamination from the blood draw.

The following bacterial organisms and resistance marker genes are identified using the BCID-GP Panel:

TABLE 2
List of Analytes of the BCID-GP Panel
List of Analytes for the BCID-GP Panel

Bacillus cereus group. Staphylococcus epidermidis, Bacillus subtilis group, Staphylococcus
lugdunensis, Corynebacterium spp., Streptococcus, Enterococcus, Streptococcus agalactiae,
Enterococcus faecalis, Streptococcus anginosus group, Enterococcus faecium, Streptococcus
pneumonia, Lactobacillus, Streptococcus pyogenes, Listeria, Pan Gram-negative target (at
least Enterobacteriaceae, Acinetobacter, Pseudomonas, Bacteroides, Stenotrophomonas),
Listeria monocytogenes, Pan Candida target (Candida albicans, Candida glabrata, Candida
krusei, Candida parapsilosis), Micrococcus, Propionibacterium acnes, Staphylococcus,
Staphylococcus aureus, mecA, mecC, vanA, and vanB.

Gram-Negative Panel

The BCID-GN Panel is a fully automated, qualitative, nucleic acid, multiplex in vitro diagnostic test for simultaneous detection and identification of multiple potentially pathogenic gram-negative bacterial organisms and select determinants of antimicrobial resistance in positive blood culture. The test also detects but does not differentiate gram-positive bacteria and several pathogenic Candida species. The test is able to detect 21 bacterial targets and 6 resistance genes, as well as multiple Candida species from a single cartridge (single PCR run) and most major gram-positive organisms, also as on a single cartridge (single PCR run).

The following bacterial organisms are identified using the BCID-GN Panel:

TABLE 3
List of Analytes of the BCID-GN Panel
List of Analytes for the BCID-GN Panel

Acinetobacter baumannii, Klebsiella pneumoniae, Bacteroides fragilis, Morganella morganii,
Citrobacter, Neisseria meningitides, Cronobacter sakazakii, Proteus, Enterobacter cloacae
complex, Proteus mirabilis, Enterobacter (non-cloacae complex), Pseudomonas aeruginosa,
Escherichia coli, Salmonella, Fusobacterium necrophorum, Serratia, Fusobacterium
nucleatum, Serratia marcescens, Haemophilus influenza, Stenotrophomonas maltophilia,
Klebsiella oxytoca. The following Antimicrobial Resistance Markers are identified using the
BCID-GN Panel: CTX-M, NDM, IMP, OXA, KPC, VIM.
The following Pan Targets are identified using the BCID-GN Panel: Pan Candida (Candida
albicans, Candida glabrata, Candida krusei, Candida parapsilosis)
Pan Gram-Positive (S. anginosus group, Enterococcus, Staphylococcus, Streptococcus,
Bacillus subtilis group, Bacillus cereus group, Enterococcus faecalis)

Fungal Panel

The Blood Culture Identification Fungal Pathogen Panel (BCID-FP Panel) is a fully automated, qualitative, nucleic acid, multiplex in vitro diagnostic test for simultaneous detection and identification of multiple potentially pathogenic fungal organisms in positive blood culture. The BCID-FP Panel is performed directly on blood culture samples identified as positive by a continuously monitoring blood culture system that demonstrates the presence of organisms as confirmed by Gram stain.

The following fungal organisms are identified using the BCID-FP Panel:

TABLE 4
List of Analytes of the BCID-FP Panel
List of Analytes for the BCID-FP Panel

Candida auris, Candida albicans, Candida dubliniensis, Candida famata, Candida glabrata,
Candida guilliermondii, Candida kefyr, Candida lusitaniae, Candida krusei, Candida
parapsilosis, Candida tropicalis, Cryptococcus gattii, Cryptococcus neoformans, Fusarium,
Malassezia furfur, Rhodotorula, and Trichosporon.
Schizosaccharomyces pombe, Malaessezia furfur, Candida albicans, and Candida auris get
a species call. For the Fusarium call, the BCID-FP panel detects but does not identify the
following species in the call (report): solani set, dimerum, proliferatum, moniliforme,
verticillioides, oxysporum, and sacchari.
For the Rhodotorula call, the BCID-FP panel detects but does not identify the following
species in the call (report): mucilaginosa, and glutinis. For the Trichosporon call, the BCID-
FP panel detects but does not identify the following species in the call (report): asteroid,
coremiiforme and dermatis.

### Method(s) of the Invention(s)

In one embodiment the method of the invention comprises or consists of the following steps: a) providing a sample, preferably a blood culture, blood, serum or plasma sample, b) after nucleic acid extraction, bringing said sample into contact with a mixture of oligonucleotides and reagents for carrying out a nucleic acid amplification reaction by applying a compressive force through a label to a fluid filed blister, c) carrying out a nucleic acid amplification reaction, and d) detecting and evaluating the amplification products generated as a result of said nucleic acid amplification reaction.

In general, the method is suitable for detection of a respiratory virus or bacterial (gram positive or gram negative) or fungal or Central Nervous System (CNS), or Gastrointestinal (GI) infection in a sample. The identification of a pathogen may occur such that the detection report provides “virus” or “bacteria” or “fungal” or “Gram-positive” or “gram-negative” as an appropriate result. The identification of a pathogen may occur such that the detection report provides the viral species name, bacteria species name, fungal species name or both as an appropriate result. The viruses, bacteria and fungi specifically contemplated to be detected are those listed in Tables 1-4.

The RP, BCID-GN, BCID-GP and BCID-FP panels can be run on an automated nucleic acid testing system including extraction, amplification, and detection, combining electrowetting and electrochemical detection. Electrochemical detection technology is based on the principles of competitive DNA hybridization and electrochemical detection, which is highly specific and is not based on fluorescent or optical detection. The use of microfluidic systems in the electrochemical detection of target analytes is described in more detail in U.S. Pat. Nos. 9,557,295, 8,501,921, 6,600,026, 6,740,518 and U.S. publication no. 20160129437 which are herein incorporated by reference in their entirety.

The automated nucleic acid testing system aha electrochemical detection system described above includes a) an instrument bank comprising a plurality of biochip cartridge bays for insertion and analysis of a biochip cartridge, wherein each bay comprises: i) a top bay comprising actuators and compressors for a liquid reagent module (LRM); and ii) a bottom bay comprising electrical connections for an electrowetting electrode grid and detection electrodes; and b) a base station comprising: i) a central processing unit; and ii) a user interface comprising a touch screen display having a plurality of bay icons, each icon uniquely corresponding to one of said plurality of bays. The sample-to-answer system is generally described in U.S. Patent publication no. 2014-0194305, U.S. Pat. No. 9,598,722 and Provisional U.S. Patent Application 62/396,449 all of which are incorporated by reference in their entirety.

Detection of Amplification Products

Electrowetting, or digital microfluidics, uses electrical fields to directly-manipulate discrete droplets on the surface of a hydrophobically coated printed circuit board (PCB). Sample and reagents are moved in a programmable fashion in the cartridge to complete all portions of the sample processing from nucleic acid extraction to detection.

A sample is loaded into the cartridge and the cartridge is placed into the instrument. Nucleic acids are extracted and purified from the specimen via magnetic solid phase extraction (i.e. the use of magnetic beads to pre-concentrate analytes or targets, then move (elute) the beads containing the targets to a different location, where the targets are released for post-elution events. PCR is used to created double-stranded cDNA which is treated with exonuclease to create single-stranded DNA in preparation for electrochemical detection.

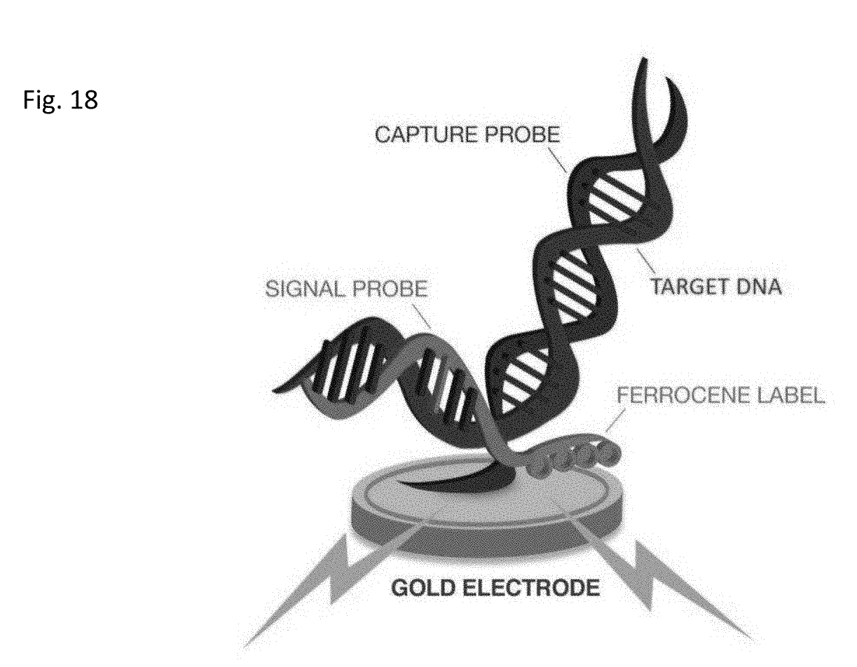

The target amplicons are mixed with ferrocene-labeled signal probes that are complementary to the specific targets on the panel. Target sequences hybridize to the complementary signal probe and capture probes, which are bound to gold-plated electrodes, as shown in FIG. 18. The presence of each target is determined by voltammetry which generates specific electrical signals from the ferrocene-labeled signal probe. Specifically, FIG. 18 shows the hybridization complex. Target-specific capture probes are bound to the gold electrodes in the microarray on the cartridge. The amplified target DNA hybridizes to the capture probe and to a complementary ferrocene-labeled signal probe. The electrochemical analysis determines the presence or absence of targets using voltammetry. The use of microfluidic systems in the electrochemical detection of target analytes is described in more detail in U.S. Pat. Nos. 9,557,295, 8,501,921, 6,600,026, 6,740,518 and U.S. publication no. 2016-0129437 which are herein incorporated by reference in their entirety.

Initial sample processing begins with blood draw, removal of blood from the tube at the lab centrifugation, gram stain. Following gram stain, sample processing is summarized here: Step −1. Obtain sample after gram stain; Step 0. Load Sample; step 1. Combine Lysis Buffer with Sample (LRM), beads and Dispense Oil (Cartridge sub-assembly); step 2. Combine Binding Buffer with Sample (LRM) and Dispense Reconstitution Buffer (cartridge sub-assembly); step 3. Separate beads from sample bead mixture (LRM) and Rehydrate PCR reagent (cartridge sub-assembly); step 4. Wash beads with Wash buffer (LRM) and Rehydrate PCR reagent (cartridge sub-assembly); step 5. Flush beads from LRM into cartridge; step 6. Final bead wash in cartridge sub-assembly and Quick Rinses (cartridge sub-assembly); step 7. Elute target analyte from beads; step 8. Combine PCR reagent with elute target (analyte); step 9. Dispense analyte drops mix into PCR staging area; step 10. Rehydrate PCR primers cocktail with each analyte drop; step 11. Transfer eluted analyte to thermal-cycling PCR area in the cartridge; step 12. Convert RNA into DNA with Reverse Transcriptase (optional step); step 13. Perform PCR cycling; step 14. Rehydrate exonuclease reagent; step 15. Combine PCR products with exonuclease reagent (ssDNA conversion); step 16. Exonuclease incubation and combine with Signal Probe cocktail (detection); step 17. Deliver PCR products and signal probe into Detection area; step 18. Incubate in eSensor area with capture probe bound to gold electrode; step 19. Scan and detect target analyte; step 20. Eject cartridge. As discussed above, prior to loading the sample can be pre-filtered.

The basic microfluidic platform used herein is based on systems developed by Advanced Liquid Logic (ALL, currently a subsidiary of Illumina, Inc.), as more fully described in U.S. Patent app. no. 20140194305 (which is incorporated by reference in its entirety). In general, these technologies rely on the formation of microdroplets and the ability to independently transport, merge, mix and/or process the droplets, using electrical control of surface tension (i.e., electrowetting). In general, liquid samples are contained within a microfluidic device between two parallel plates. One plate contains etched drive electrodes on its surface while the other plate contains either etched electrodes or a single, continuous plane electrode that is grounded or set to a reference potential (“biplanar electrowetting”). Hydrophobic insulation covers the electrodes and an electric field is generated between electrodes on opposing plates. This electric field creates a surface-tension gradient that causes a droplet overlapping the energized electrode to move towards that electrode. In some embodiments, the active electrowetting electrodes may be adjacent and on the same plane as the neighboring ground reference electrode, which is referred to as “coplanar electrowetting”). Through proper arrangement and control of the electrodes, a droplet can be transported by successively transferring it between adjacent electrodes. The patterned electrodes can be arranged in a two dimensional array so as to allow transport of a droplet to any location covered by that array. The space surrounding the droplets may be filled with a gas such as air or an immiscible fluid such as oil, with immiscible oils being preferred embodiments of the present invention. Indeed, the immiscible fluid may be a synthetic silicone oil. This silicone oil is present throughout the system, i.e., during amplification and detection.

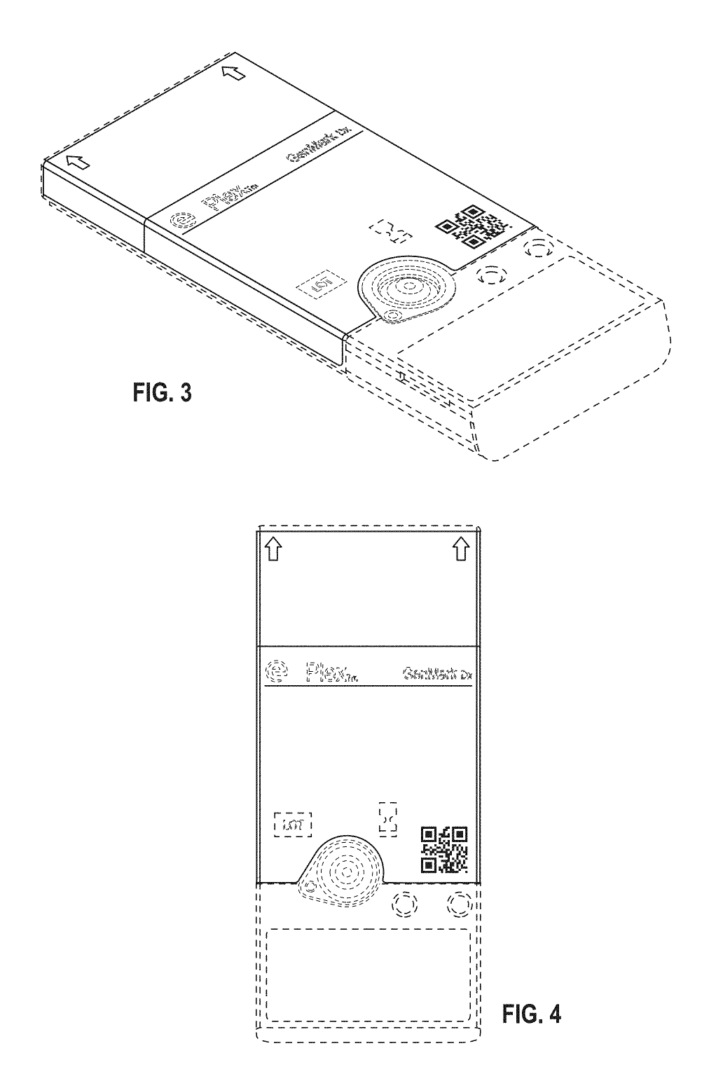

Signal probes are used in the electrochemical detection of target analytes on the surface of a monolayer. QW56 or QW80 are ferrocene labeled signal probes that can be prepared using routine DNA synthesis techniques essentially as described in commonly owned application PCT/US08/82666 (published as WO/2009/061941A2 and U.S. Pat. No, 7,820,391 which are herein incorporated by reference in its entirety). In U.S. publication no. 2014-0323326 (which is herein incorporated by reference in its entirety), FIG. 3A depicts QW 56 and FIG. 3B depicts QW80. N6 (a ferrocene labeled signal probe) is another label that can be used; its synthesis is described in commonly owned U.S. Pat. No. 7,393,645 which is herein incorporated by reference in its entirety.

Capture probes are used in the electrochemical detection of target analytes on the surface of a monolayer. Specifically, capture binding ligands (called capture probes when the target analyte is a nucleic acid) anchor target analytes to the electrode surface and form an assay complex. The assay complex further comprises an electron transfer moiety (ETM), that is directly or indirectly attached to the target analyte. That is, the presence of the ETM near the electrode surface is dependent on the presence of the target analyte. Electron transfer between the ETM and the electrode is initiated using a variety of techniques as known by those of skill in the art, and the output signals received and optionally processed as further known by those of skill in the art. Thus, by detecting electron transfer, the presence or absence of the target analyte is determined.

In general, there are two basic detection mechanisms that may be used. In a preferred embodiment, detection of an ETM is based on electron transfer through the stacked π-orbitals of double stranded nucleic acid. This basic mechanism is described in U.S. Pat. Nos. 5,591,578, 5,770,369, 5,705,348, and PCT US97/20014 and is termed “mechanism-1” herein. Briefly, previous work has shown that electron transfer can proceed rapidly through the stacked π-orbitals of double stranded nucleic acid, and significantly more slowly through single-stranded nucleic acid. Accordingly, this can serve as the basis of an assay. Thus, by adding ETMs (either covalently to one of the strands or non-covalently to the hybridization complex through the use of hybridization indicators, described below) to a nucleic acid that is attached to a detection electrode via a conductive oligomer, electron transfer between the ETM and the electrode, through the nucleic acid and conductive oligomer, may be detected.

Alternatively, the presence or absence of ETMs can be directly detected on a surface of a monolayer. That is, the electrons from the ETMs need not travel through the stacked π orbitals in order to generate a signal. As above, in this embodiment, the detection electrode preferably comprises a self-assembled monolayer (SAM) that serves to shield the electrode from redox-active species in the sample. In this embodiment, the presence of ETMs on the surface of a SAM, that has been formulated to comprise slight “defects” (sometimes referred to herein as “microconduits”, “nanoconduits” or “electroconduits”) can be directly detected. This basic idea is termed “mechanism-2” herein. Essentially, the electroconduits allow particular ETMs access to the surface. Without being bound by theory, it should be noted that the configuration of the electroconduit depends in part on the ETM chosen. For example, the use of relatively hydrophobic ETMs allows the use of hydrophobic electroconduit forming species, which effectively exclude hydrophilic or charged ETMs. Similarly, the use of more hydrophilic or charged species in the SAM may serve to exclude hydrophobic ETMs. Thus, in either embodiment, an assay complex is formed that contains an ETM, which is then detected using the detection electrode and the signal processing techniques outlined herein.

Moreover, as specifically described in U.S. Pat. No. 6,740,518 which is herein incorporated by reference in its entirety, monitoring of the output signal at higher harmonic frequencies can be used to achieve higher signal to noise ratios, to increase the detection limits of target analytes. For example, the ferrocene response reacts non-linearly, producing a harmonic response in the signal above that in the background; this harmonic signal from AC voltammetry is most likely the result of a harmonic distortion due to the nonlinear response of the electrochemical cell; see Yap, J. of Electroanalytical Chem. 454:33 (1998); hereby incorporated by reference. Thus, any techniques that increase this non-linearity are desirable. In a preferred embodiment, techniques are used to increase the higher harmonic signals; thus, frequency and phase-sensitive lock-in detection is performed at both the fundamental frequency of the applied waveform and also at multiples of the fundamental frequency (i.e. the higher harmonics). Since the background capacitance responds relatively linearly to AC signals (a sine wave input AC voltage results in a relatively nondistorted sine wave output), very little upper harmonic current is produced in the background. This gives a dramatic increase in the signal to noise ratio. Thus, detection at the higher harmonic frequencies, particularly the third, fourth and fifth harmonics (although the harmonics from second to tenth or greater can also be used) is shown to result in dramatic suppression of the background currents associated with non-Faradaic processes (like double layer charging) that can overwhelm the signal from the target molecules. In this way, the evaluation of the system at higher harmonic frequencies and phases can lead to significant improvements in the detection limits and clarity of signal. Thus, in a preferred embodiment, one method of increasing the non-linear harmonic response is to increase or vary the amplitude of the AC perturbation, although this may also be used in monitoring the fundamental frequency as well Thus, the amplitude may be increased at high frequencies to increase the rate of electron transfer through the system, resulting in greater sensitivity. In addition, this may be used, for example, to induce responses in slower systems such as those that do not possess optimal spacing configurations.

Electrode initialization is another signal processing method to achieve higher signal to noise ratios, and to increase the detection limits of target analytes. In general, in any system, the observed signal is a combination of signal from the target analyte (sample signal) and signal from the background, or noise. Electrode initialization provides variations in initiation signals (e.g. varying the “input”) that can be used to increase the signal, decrease the noise, or make the signal more obvious or detectable in a background of noise. In an embodiment, the input signal is AC/DC offset. In an embodiment, the AC frequency ranges from 90-1000 Hz. In an embodiment, the AC voltage ranges from −150 to 880 mV rms. In an embodiment, electrode initialization is performed for 0.5-5 seconds and then stopped as described in U.S. patent application Ser. No. 14/218,615 which is herein incorporated by reference in its entirety.

These techniques are generally described in U.S. Publication no. 2014-0194305and U.S. Pat. Nos. 4,887,455; 5,591,578; 5,705,348; 5,770,365; 5,807,701; 5,824,473; 5,882,497; 6,013,170; 6,013,459; 6,033,601; 6,063,573; 6,090,933; 6,096,273; 6,180,064; 6,190,858; 6,192,351; 6,221,583; 6,232,062; 6,236,951; 6,248,229; 6,264,825; 6,265,155; 6,290,839; 6,361,958; 6,376,232; 6,431,016; 6,432,723; 6,479,240; 6,495,323; 6,518,024; 6,541,617; 6,596,483; 6,600,026; 6,602,400; 6,627,412; 6,642,046; 6,655,010; 6,686,150; 6,740,518; 6,753,143; 6,761,816; 6,824,669; 6,833,267; 6,875,619; 6,942,771; 6,951,759; 6,960,467; 6,977,151; 7,014,992; 7,018,523; 7,045,285; 7,056,669; 7,087,148; 7,090,804; 7,125,668; 7,160,678; 7,172,897; 7,267,939; 7,312,087; 7,381,525; 7,381,533; 7,384,749; 7,393,645; 7,514,228; 7,534,331; 7,560,237; 7,566,534; 7,579,145; 7,582,419; 7,595,153; 7,601,507; 7,655,129; 7,713,711; 7,759,073; 7,820,391; 7,863,035; 7,935,481; 8,012,743; 8,114,661, 9,598,722, all of which are incorporated by reference in their entirely,

Identification, detection or reporting results occurs when amplified target DNA hybridizes to its complementary signal probe and capture probes. Identification, detection or reporting results occurs when amplified target DNA hybridizes to its complementary signal probe and capture probes wherein the capture probe is bound to gold-plated electrodes. Identification, detection or reporting results occurs when a hybridization complex forms between the target DNA and signal and capture probes.

A number of nucleic acid amplification test (NAAT) methods suitable for use with the invention are available. They include the well-known PCR, the ligase chain reaction (LCR), strand displacement amplification (SDA), recombinase-polymerase amplification (RPA), transcription mediated amplification, nucleic acid sequence-based amplification (NASBA), Helicase-dependent amplification and loop-mediated isothermal amplification.

The reagents for nucleic acid detection may be specific for the particular target nucleic acid, i.e. they may allow for detection of the presence of the specific nucleic acid sequence. As an alternative, the reagents for nucleic acid detection may be generic reagents to detect the presence of any nucleic acids. Such generic reagents may be used if all nucleic acids other than the target nucleic acid are removed prior to detection. For example, this may be achieved by providing a nuclease that is capable of hydrolysing all nucleic acids present in the sample other than the target nucleic. The amplified target nucleic acid can be protected from hydrolysis, for example by inclusion of chemical modifications in the primers which are incorporated into the amplified product and which cannot be hydrolysed. Reagents for nucleic acid detection are described below in relation to an exemplary cartridge but usually comprise a probe including a label. The probe is capable of hybridising to the amplified nucleic acid which has been amplified in the amplification chamber(s). Following hybridisation of the probe to the amplified nucleic acid, the detection of the nucleic acid may occur via a detectable change in the signal from the label. In some embodiments the change may be caused by hydrolysis of the probe. Where the probe is hydrolysed, hydrolysis is usually achieved using a double strand specific nuclease, which can be an exonuclease or an endonuclease. Preferably, the nuclease is T7 endonuclease. The signal from the label is capable of undergoing a change following hydrolysis of the probe. This is due to a change in the environment of the label when it moves from being bound to the rest of the probe to being free from the rest of the probe or bound to a single nucleotide or a short part of the probe. Further details of the types of probes and detection methods that may be used can be found in Hillier et al. Bioelectrochemistry, 63 (2004), 307-310. As an alternative, methods for causing a detectable change in the signal from the label which do not rely on hydrolysis of the probe may be used e.g. see Ihara et al. Nucleic Acids Research, 1996, Vol. 24, No. 21 4273-4280. This change in environment of the label leads to a change in the signal from the label. The change in signal from the label can be detected in order to detect the presence of the nucleic acid of interest.

Other method of detecting a target nucleic acid sequence in a nucleic acid solution are described in U.S. Pat. No. 9,127,308 and comprise: contacting a nucleic acid solution with an oligonucleotide probe labeled at the 5′-terminal with an electrochemically active marker; hybridizing the oligonucleotide probe with a complementary target sequence present in the nucleic acid solution and thereby forming a double stranded hybridized nucleic acid; degrading the double stranded hybridized nucleic acid by digestion with a duplex specific 5′ to 3′ exonuclease to form a mononucleotide degraded probe labeled with the electrochemically active marker or a dinucleotide probe labeled with the electrochemically active marker; electrochemically discriminating a redox based signal of the mononucleotide probe or the dinucleotide probe from any undegraded or unhybridized oligonucleotide probe in the solution, wherein the redox based signal is influenced by at least the size of the probe to which the electrochemically active marker is attached; and detecting the target nucleic acid based on the discrimination of the redox based signal from the mononucleotide probe or the dinucleotide probe from any undegraded or unhybridized oligonucleotide probe.

Other method of detecting a target nucleic acid sequence in a nucleic acid solution include dyes that fluoresce differentially when bound to double-stranded DNA than when bound to single-stranded DNA or free in solution, usually by fluorescing more strongly. Other method of detecting a target nucleic acid sequence in a nucleic acid solution include a fluorescence-based probe system for analyzing a target nucleic acid consisting essentially of a single-labeled polynucleotide comprising a sequence generally complementary to a locus of the nucleic acid and a fluorescent label attached to a terminal nucleotide, wherein the terminal nucleotide is a base analog, whereby upon hybridization of the single-labeled polynucleotide to the locus of the nucleic acid the fluorescent label is positioned near a residue of the target nucleic acid with a resultant increase in fluorescent intensity of the fluorescent label.

The invention(s) can be further understood by the following numbered paragraphs:

Paragraph 1. A microfluidic device comprising:

an inlet for receiving a sample containing genetic material;

an amplification area

a detection zone.

Paragraph 1: An in vitro method for the detection and/or identification of a human pathogen and/or genetic material thereof comprising: a) loading a sample in a cartridge comprising a label and a compressible pouch, b) releasing fluid from the compressible pouch by applying a compressive force to the label and the compressible pouch, c) carrying out a nucleic acid amplification reaction, and d) detecting and evaluating the amplification products generated as a result of said nucleic acid amplification reaction.

Paragraph 2: The method of Paragraph 1, wherein the human pathogen is a respiratory, gram-positive bacteria, gram-negative bacteria, fungal, Central Nervous System (CNS), or Gastrointestinal (GI) infection.

Paragraph 3: The method of Paragraph 1, wherein the human pathogen is influenza A, adenovirus influenza A H1 subtype, human metapneumovirus, influenza A H3 subtype, human rhinovirus/enterovirus, influenza A 2009 H1N1 subtype, coronavirus 229e, influenza B, coronavirus respiratory syncytial virus A, coronavirus nl63, respiratory syncytial virus B, coronavirus OC4, parainfluenza virus 1, bordetella pertussis, parainfluenza virus 2, chlamydophila pneumoniae, parainfluenza virus 3, mycoplasma pneumoniae or parainfluenza virus 4.

Paragraph 4: The method of Paragraph 1, wherein the human pathogen is Bacillus cereus group, Staphylococcus epidermidis, Bacillus subtilis group, Staphylococcus lugdunensis, Corynebacterium spp., Streptococcus, Enterococcus, Streptococcus agalactiae, Enterococcus faecalis, Streptococcus anginosus group, Enterococcus faecium, Streptococcus pneumonia, Lactobacillus, Streptococcus pyogenes, Listeria, Pan Gram-negative target (at least Enterobacteriaceae, Acinetobacter, Pseudomonas, Bacteroides, Stenotrophomonas), Listeria monocytogenes, Pan Candida target (Candida albicans, Candida glabrata, Candida krusei, Candida parapsilosis), Micrococcus, Propionibacterium acnes, Staphylococcus, or Staphylococcus aureus.

Paragraph 5: The method of Paragraph 1, wherein the human pathogen is Acinetobacter baumannii, Klebsiella pneumoniae, Bacteroides fragilis, Morganella morganii, Citrobacter, Neisseria meningitides, Cronobacter sakazakii, Proteus, Enterobacter cloacae complex, Proteus mirabilis, Enterobacter (non-cloacae complex). Pseudomonas aeruginosa, Escherichia coli, Salmonella, Fusobacterium necrophorum, Serratia, Fusobacterium nucleatum, Serratia marcescens, Haemophilus influenza, Stenotrophomonas maltophilia, Klebsiella oxytoca.

Paragraph 6: The method of Paragraph 1, wherein the human pathogen is Candida auris, Candida albicans, Candida dubliniensis, Candida famata, Candida glabrata, Candida guilliermondii, Candida kefyr, Candida lusitaniae, Candida krusei, Candida parapsilosis, Candida tropicalis, Cryptococcus gattii, Cryptococcus neoformans, Fusarium, Malassezia furfur, Rhodotorula, or Trichosporon.

Paragraph 7: The method of Paragraph 1, wherein the human pathogen identified is automatically reported to a hospital's laboratory information system (LIS).

Paragraph 8: A microfluidic device for detecting a human pathogen and/or genetic material thereof comprising: A) a reaction module; B) a liquid reagent module (LRM) comprising a plurality of blisters; C) an external housing having open areas over at least one of the plurality of blisters; and D) a label affixed to the external housing and over at least one of the open areas.

Paragraph 9: The device of Paragraph 8, wherein the human pathogen is a respiratory, gram-positive bacteria, gram-negative bacteria, fungal, Central Nervous System (CNS), or Gastrointestinal (GI) infection.

Paragraph 10: The device of Paragraph 8, wherein the human pathogen is influenza A, adenovirus influenza A H1 subtype, human metapneumovirus, influenza A H3 subtype, human rhinovirus/enterovirus, influenza A 2009 H1N1 subtype, coronavirus 229e, influenza B, coronavirus HKU1, respiratory syncytial virus A, coronavirus nl63, respiratory syncytial virus B, coronavirus OC4, parainfluenza virus 1, Bordetella pertussis, parainfluenza virus 2, chlamydophila pneumoniae, parainfluenza virus 3, mycoplasma pneumoniae or parainfluenza virus 4.

Paragraph 11: The device of Paragraph 8, wherein the human pathogen is Bacillus cereus group, Staphylococcus epidermidis, Bacillus subtilis group, Staphylococcus lugdunensis, Corynebacterium spp., Streptococcus, Enterococcus, Streptococcus agalactiae, Enterococcus faecalis, Streptococcus anginosus group, Enterococcus faecium, Streptococcus pneumonia, Lactobacillus, Streptococcus pyogenes, Listeria, Pan Gram-negative target (at least Enterobacteriaceae, Acinetobacter, Pseudomonas, Bacteroides, Stenotrophomonas), Listeria monocytogenes, Pan Candida target (Candida albicans, Candida glabrata, Candida krusei, Candida parapsilosis), Micrococcus, Propionibacterium acnes, Staphylococcus, or Staphylococcus aureus.

Paragraph 12: The device of Paragraph 8, wherein the human pathogen is Acinetobacter baumannii, Klebsiella pneumoniae, Bacteroides fragilis, Morganella morganii, Citrobacter, Neisseria meningitides, Cronobacter sakazakii, Proteus, Enterobacter cloacae complex, Proteus mirabilis, Enterobacter (non-cloacae complex), Pseudomonas aeruginosa, Escherichia coli, Salmonella, Fusobacterium necrophorum, Serratia, Fusobacterium nucleatum, Serratia marcescens, Haemophilus influenza, Stenotrophomonas maltophilia, Klebsiella oxytoca.

Paragraph 13: The device of Paragraph 8, wherein the human pathogen is Candida auris, Candida albicans, Candida dubliniensis, Candida famata, Candida glabrata, Candida guilliermondii, Candida kefyr, Candida lusitaniae, Candida krusei, Candida parapsilosis, Candida tropicalis, Cryptococcus gattii, Cryptococcus neoformans, Fusarium, Malassezia furfur, Rhodotorula, or Trichosporon.

Paragraph 14: A system for detecting a human pathogen and/or genetic material thereof comprising: A) an instrument comprising a compressor and a cartridge carrier assembly; B) a cartridge comprising a compressible pouch, an external housing and a label.

Paragraph 15: The system of Paragraph 14, wherein the compressor compresses the label and the compressible pouch releasing fluid, gas or a solid from the compressible pouch.

Paragraph 16: The system of Paragraph 14, wherein the human pathogen is a respiratory, gram-positive bacteria, gram-negative bacteria, fungal, Central Nervous System (CNS), or Gastrointestinal (GI) infection.

Paragraph 17: The system of Paragraph 14, wherein the human pathogen is influenza A, adenovirus influenza A H1 subtype, human metapneumovirus, influenza A H3 subtype, human rhinovirus/enterovirus, influenza A 2009 H1N1 subtype, coronavirus 229e, influenza B, coronavirus HKU1, respiratory syncytial virus A, coronavirus nl63, respiratory syncytial virus B, coronavirus OC4, parainfluenza virus 1, Bordetella pertussis, parainfluenza virus 2, chlamydophila pneumoniae, parainfluenza virus 3, mycoplasma pneumoniae or parainfluenza virus 4.

Paragraph 18: The system of Paragraph 14, wherein the human pathogen is Bacillus cereus group, Staphylococcus epidermidis, Bacillus subtilis group, Staphylococcus lugdunensis, Corynebacterium spp., Streptococcus, Enterococcus, Streptococcus agalactiae, Enterococcus faecalis, Streptococcus anginosus group, Enterococcus faecium, Streptococcus pneumonia, Lactobacillus, Streptococcus pyogenes, Listeria, Pan Gram-negative target (at least Enterobacteriaceae, Acinetobacter, Pseudomonas, Bacteroides, Stenotrophomonas), Listeria monocytogenes, Pan Candida target (Candida albicans, Candida glabrata, Candida krusei, Candida parapsilosis), Micrococcus, Propionibacterium acnes, Staphylococcus, or Staphylococcus aureus.

Paragraph 19: The system of Paragraph 14, wherein the human pathogen is Acinetobacter baumannii, Klebsiella pneumoniae, Bacteroides fragilis, Morganella morganii, Citrobacter, Neisseria meningitides, Cronobacter sakazakii, Proteus, Enterobacter cloacae complex, Proteus mirabilis, Enterobacter (non-cloacae complex), Pseudomonas aeruginosa, Escherichia coli, Salmonella, Fusobacterium necrophorum, Serratia, Fusobacterium nucleatum, Serratia marcescens, Haemophilus influenza, Stenotrophomonas maltophilia, Klebsiella oxytoca.

Paragraph 20: The system of Paragraph 14, wherein the human pathogen is Candida auris, Candida albicans, Candida dubliniensis, Candida famata, Candida glabrata, Candida guilliermondii, Candida kefyr, Candida lusitaniae, Candida krusei, Candida parapsilosis, Candida tropicalis, Cryptococcus gattii, Cryptococcus neoformans, Fusarium, Malassezia furfur, Rhodotorula, or Trichosporon.

The invention(s) can be further understood by the following numbered paragraphs:

Paragraph 1: A disposable fluidic cartridge comprising: a body having a recess therein and a mechanically-actuatable mechanism disposed within the recess for effecting an operation of the fluidic cartridge; and further comprising: a machine-readable identification code on a label, the label covering at least a portion of the recess such that the portion of the label covering the recess is configured to separate but not detach upon insertion of a mechanical actuator into the recess to actuate the mechanically-actuatable mechanism, thereby rendering the identification code unreadable and preventing reuse of the cartridge.

Paragraph 2: The cartridge of Paragraph 1, wherein the mechanically-actuatable mechanism is a collapsible blister configured to expel its contents into a fluid pathway within the fluidic cartridge as it is collapsed.

Paragraph 3: The cartridge of Paragraph 2, for use in diagnostic testing, wherein the collapsible blister contains a liquid component for conducting a diagnostic test.

Paragraph 4: The cartridge of Paragraph 3, wherein the liquid component is one of a reagent, a lysis buffer, a wash buffer and an elution buffer.

Paragraph 5: The cartridge of any preceding paragraph, wherein the label further comprises a machine-readable identification code is a bar-code, a QR-code or a letter code, a number code or a alphanumeric code.

Paragraph 6: The cartridge of paragraph 5, wherein the machine-readable identification code takes up an area on label having a length and a width, and wherein at least one the length and the width of said area is fully contained within the portion of the label covering the recess.

Paragraph 6a: The cartridge of paragraph 5, wherein the portion of the label covering the recess is configured to separate but not detach upon insertion of a mechanical actuator into the recess to actuate the mechanically-actuatable mechanism forms a chad and wherein the machine-readable identification code takes up an area on the label having a length and a width, and wherein at least one the length and the width of said area is fully contained within the chad.

Paragraph 7: A cartridge reader configured to receive a fluidic cartridge having a recess, a mechanically-actuatable mechanism disposed within the recess for effecting an operation of the fluidic cartridge, and label comprising a serpentine separation line, the reader comprising: a compression mechanism configured to extend into the recess to actuate the mechanically-actuatable mechanism and separate the portion of the label covering the recess.

Paragraph 7a: A cartridge reader configured to receive a disposable fluidic cartridge having a recess, a mechanically-actuatable mechanism disposed within the recess for effecting an operation of the fluidic cartridge, and a machine-readable identification code on a label covering at least a portion of the recess, the reader comprising: a sensor for detecting the identification code of a disposable cartridge inserted into the cartridge reader; and a mechanical actuator configured extend into the recess to actuate the mechanically—actuatable mechanism and separate but not detach the portion of the label covering the recess thereby rendering the identification code unreadable and preventing reuse of the cartridge; wherein: the reader is configured to extend the mechanical actuator into a recess of a cartridge inserted into the reader only if the sensor detects an identification code on the that—cartridge

Paragraph 8: The cartridge reader of Paragraph 7, wherein the actuator is a foot configured to separate the portion of the label covering the recess and collapse a collapsible chamber located within the recess of the cartridge.

Paragraph 9: The cartridge reader of Paragraph 8, wherein the cartridge reader is configured to perform a diagnostic test on a sample in a cartridge inserted into the reader.

Paragraph 10: A method of using a disposable fluidic cartridge having a recess, a mechanically-actuatable mechanism disposed within the recess for effecting an operation of the fluidic cartridge, and a machine-readable identification code on a label covering at least a portion of the recess, the method comprising: inserting the disposable cartridge within a cartridge reader; attempting to detect an identification code on the label on the disposable cartridge; and, upon successfully detecting the identification code, extending a mechanical actuator into the recess on the disposable cartridge to separate but not detach the portion of the breakable label covering the recess, thereby rendering the identification code unreadable, and actuate the mechanically-actuated mechanism.

Paragraph 11: The method of Paragraph 10, wherein the actuatable mechanism is a collapsible blister and wherein the step of actuating the actuatable mechanism comprises collapsing the collapsible blister to expel its contents into a fluid pathway within the fluidic cartridge.

Paragraph 12: The method of Paragraph 11, wherein the collapsible blister contains a liquid component for conducting a diagnostic test, the method further comprising the step of performing a diagnostic test on a sample in the cartridge. Paragraph 13: The method of Paragraph 12, wherein the liquid component is one of a reagent, a lysis buffer, a wash buffer and an elution buffer.

Paragraph 13: A method of using a fluidic cartridge having a recess, a mechanically-actuatable mechanism disposed within the recess for effecting an operation of the fluidic cartridge, and a label configured to allow a chad covering the recess to separate but not detach from the rest of the label, the method comprising: inserting the cartridge within a cartridge reader; extending a compression mechanism into the recess on the cartridge to separate but not detach the chad, and actuate the mechanically-actuated mechanism.

Sample-To-Answer System

The sample-to-answer system combines an automated nucleic acid testing system with communication capabilities to streamline the diagnostic workflow from physician order entry to the release of the final report with accurate, actionable test results.

The sample-to-answer system is designed to reduce avoidable medical errors. Preventable medical errors are now the third leading cause of death in the United States at more than 250,000 per year. See Martin A Makary, Michael Daniel. Medical error—the third leading cause of death in the US. BMJ, 2016. Automating information transfer has been shown to be effective in reducing many common errors, including patient identity checking and result transcription. The sample-to-answer system is uniquely designed with patient safety features to help address this challenge in the lab.

Bi-Directional LIS

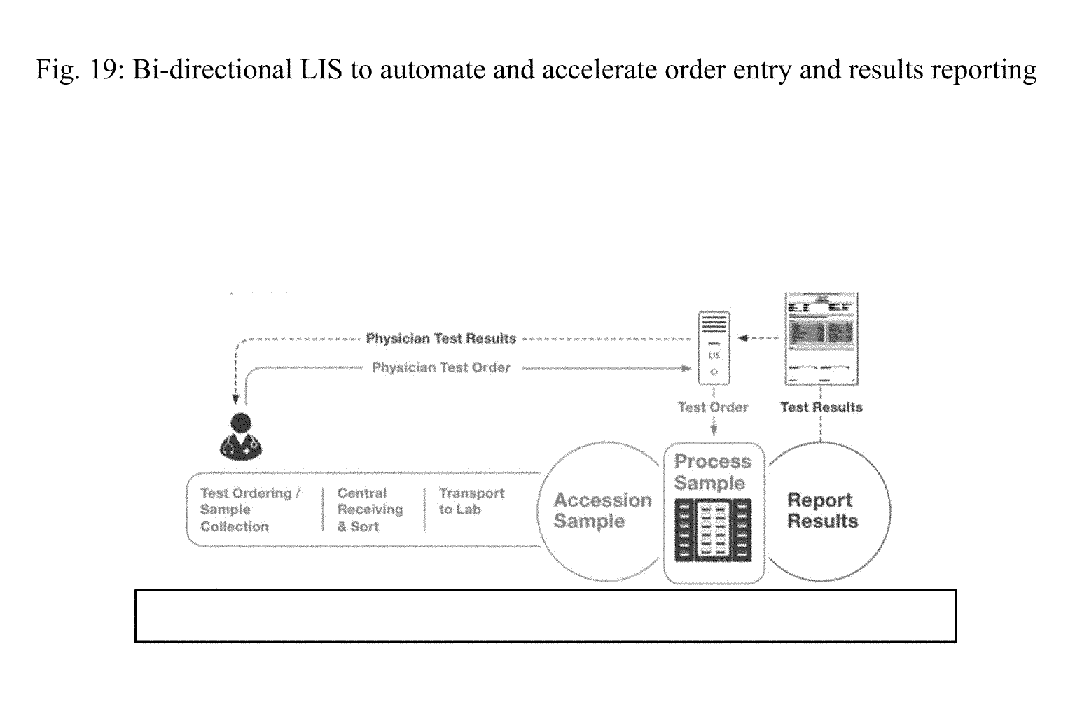

The sample-to-answer system includes a bi-directional LIS (also referred to as a communication system, an LIS communication system, bi-directional LIS communication system and the like) to automate and accelerate order entry and results reporting. See FIG. 19 for a schematic of the bi-directional LIS reporting. Specifically, when a sample is collected, the physician creates a test order called a physician test order. The physician test order allows the physician to specify a sample stability time (the time the sample is stable before results could be affected). The physician test order will further allow the physician to specify the time that a physician test order should remain on the physician test order list before processing.

Physician→Hospital LIS

After the physician test order is generated, the physician test order is sent to the hospital's laboratory information system (LIS), a computer software that processes, stores and manages data from all stages of medical processes and tests. The physician test order is accepted by the Hospital LIS and a pending test order (PTO) is created once the patient sample is received and accessioned by the lab into the hospital LIS.

Hospital LIS→LIS Interchange

The hospital's LIS sends the PTO to an LIS interchange which converts the PTO request from an HL7 or ASTM format to a CSV format and the PTO is now referred to as a test order or an interchange order or formatted test order and the like. HL7 and ASTM are a set of standards used in the transfer of information between clinical instruments and Laboratory Information Systems. In this way, the sample-to-answer system is able to communicate with any hospital LIS because it is driven by multiple standard messaging protocols such as HL7 and ASTM. In this way, if the hospital's LIS system is updated the LIS interchange can be remotely updated (an update on the clinical instrument is not required).

The sample-to-answer system further supports a “flat file format” i.e. non-standard file support for laboratories without automated interfaces (HL7 or ASTM). As such, tests can be imported and/or exported manually in a text format, CSV, TXT or XML formats. Automatic results can be released in XML format to a shared network location.

When the LIS interchange receives the PTO and reformats it to a test order, the test order is auto published with information associated with the PTO/sample such as patient identification, accession number, test ordered (BCID-GP, BCID-GN, BCID-FP etc.), patient type (e.g. pediatric, intensive care, maternity), patient location (e, g. pediatrics, ER, maternity), and/or time stamps such as sample collection, sample ordering, time received at central receiving, central receiving sort, transport to lab and/or accession of sample. These time stamps provide real-time monitoring by the instrument software of pending test order turn-around time.

LIS Interchange→Clinical Instrument's CPU

The automated nucleic acid testing system with communication capabilities is referred to as a “Clinical instrument” of sample-to-answer system. After the LIS interchange receives the test order, it sends it to the sample-to-answer system's (clinical instrument's) CPU in the base station.

The sample-to-answer system supports both serial and ethernet/RJ45 input/output connections to one or more hospital LIS.

The Sample Stability feature or Sample Stability time allows the user to specify the stability time on a per assay basis. The software tracks PTO orders and sends an alert notification when an order has violated the threshold for sample stability. The sample-to-answer system includes “cleanup rules” to automatically delete outstanding pending test orders e.g. delete a PTO if it is in the Pending Test Order queue for a predetermined time (called max PTO time), preferably for more than one week, preferably for more than two weeks.

These bi-directional LIS capabilities improve PTO to detection report turnaround time, reduce labor costs, and eliminate potential transcription errors.

The communication from the LIS interchange to the detection device's CPU can be referred to as the clinical instrument test order.

Reporting Results

Detection Reports

After the sample is run in a detection system, a result is generated. A result is generated if the amplified target DNA/nucleic acid hybridizes to its complementary signal probe and capture probes. The CPU in the base station then sends (either automatically or manually) a detection report (also referred to as a result report or test results) to the LIS interchange which converts the detection report into a physician test result report and sends the physician test result report to the hospital's LIS which then sends the physician result report to the physician or directly to the physician. The detection report/physician test result sent to the hospital's LIS or to the physician can include detected targets, non-detected targets, invalid results and/or control data. The sample-to-answer system can either auto release all information or hold all information for manual release. Alternatively, the sample-to-answer system can auto release some detection reports and hold some detection reports for manual release. For example, detected and non-detected targets can be auto-released while invalids can be manually released (i.e., released only after a lab supervisor approves for release). If the detection report shows 3 (triple infection) or fewer targets were identified/detected the detection report will automatically release to the hospital's LIS/physician. If the detection report shows greater than 3 (i.e. 4 or more) targets were identified/detected the report will be flagged, a multiple infection error alert (also called an alert notification) can be sent to the operator or physician and the sample can be automatically re-run. The detection report includes the assay ordered. If a cartridge is inserted that does not match the assay ordered (e.g. a gram-negative assay is ordered but a respiratory assay is inserted) a “mismatch alert” is sent to the operator and/or physician and/or the additional target is noted in the detection report. Anomalous results that are not auto-released can require a manager signature before manual release. Such reporting minimizes the risk of reporting errors.

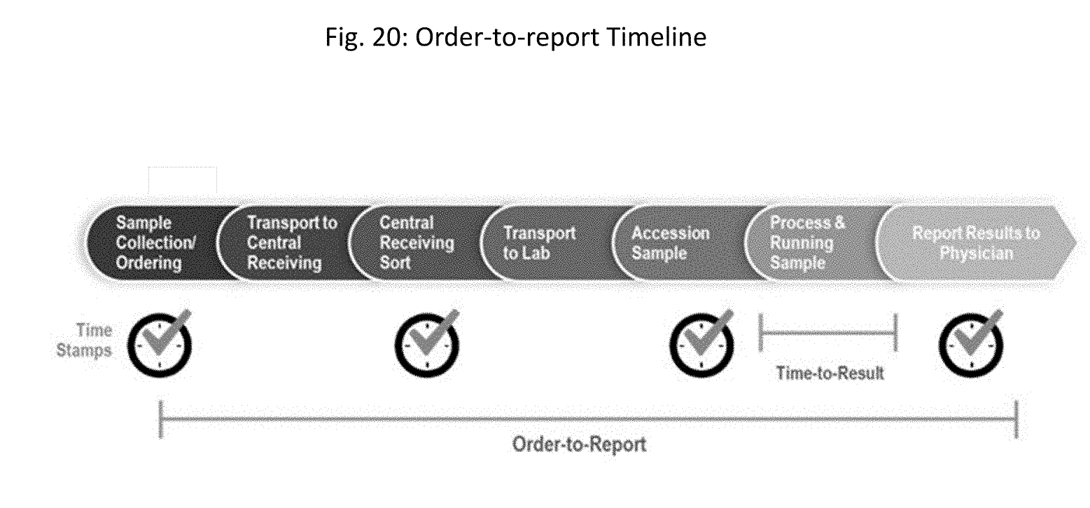

The detection report can include time stamps such as sample collection time, sample ordering time, transport to central receiving time, central receiving sort time, transport to lab time, accession of sample time, time to process, and time to detection. FIG. 20 includes an “order-to-report” timeline. The dock time stamps are commonly documented in hospital and laboratory information systems.

The automated result reporting (at order entry and results reporting) eliminates transcription errors and ensures actionable results are returned to physicians as soon as possible. Sample results are reported in about 60-90 minutes after the start of running the sample, this is referred to as time to result (See FIG. 20) or sample to result. Preferably, sample results are reported in about 60 minutes after the start of running the sample. Preferably, sample results are reported in under 90 minutes after the start of running the sample. Preferably, sample results are reported upon test completion. A detection report is sent immediately after the pathogen is identified by the detection system.

The sample-to-answer system allows the operator to include comments in the detection report called detection report comments, e.g., to specify if the assay ordered matched the target detected, if the assay ordered does not match the target detected, if an additional target was detected in addition to the target for the assay ordered, if a second assay is recommended, if a resistance gene was identified, suggest a course of treatment such as antibiotic.

Control Reports

Control reports or Control summary reports are generated based on the assay, test frequency and lot of cartridges from the supplier. Control reports provide information about the number of samples run, and when control runs are needed. When a control run is processed, the report shows the expected and actual result, if the control passed or failed. Control runs are typically run every 30 days or every lot change. The sample-to-answer system alerts to the operator 48 and/or 24 hours before a control run is needed.

System Usage Report

The system usage report provides analytics around system usage data and performance based on a specified date range. For example, the system usage report will show if higher or lower than average samples were run, if higher or lower than expected samples were run, if a bay has not been utilized, etc. System Usage Reports can be printed from the Clinical Instrument or remotely by the clinical instrument's provider.

Service Notification Report

A service notification report is a report sent to the clinical instrument's provider to request remote access to the clinical instrument to trouble shoot errors such as when a device has exceeded downtime for a month, exceeded invalid runs, mean time to failure is too high, no LIS connectivity etc.

Alerts

The sample-to-answer system includes a number of automatic alerts.

A Remote Practitioner Alert is an alert sent to practitioners to notify them that test results are available.

A Non-Operator Alert is an alert sent to non-operators such as lab-managers, directors of labs etc. regarding test results.

A Reportable Organism Alert is an alert sent based on a user-defined reportable organisms. For example, if a patient is diagnosed with an infectious disease, then an alert can be sent to the Department of Health.

A Turnaround Time Violation Alert is an alert sent to the physician, operator or lab manager when the predetermined turnaround time is violated.

A Sample Stability Time Violation Alert is an alert sent to the physician, operator or lab manager that the sample stability time was violated.

A Duplicate Accession ID Alert is an alert notifying the operator that a sample with the same accession number was already run. Since each sample should have its own accession number, the operator should review for a possible error.

A Multiple Infection Error Alert is an alert to notify the operator that there are 4 or more co-infections detected and the sample should be re-run.

A Mismatch Alert is an alert sent to the operator or physician that a target is detected which does not match the assay ordered (e.g. a gram-negative assay is ordered but a fungal infection is identified). The mismatch can be the only target detected or can be in addition to a target expected to be detected by the assay ordered. When a mismatch alert is sent the sample can be automatically re-run on the assay ordered or on another assay which matches the mismatch. For example, if the assay ordered was a BCID-GP assay but a fungal target was identified, the BCID-GP assay can be re-run and/or a BCID-FP assay is run.

### EXAMPLES

The invention is demonstrated in practical embodiments by the following examples. The embodiments disclosed therein relate to potentially preferred embodiments of the invention and are not intended to limit the scope of the invention.

### Example 1

### Label

50 consumables with intact labels (FIGS. 17A and 15B) were run in a clinical diagnostic instrument wherein during processing the label is pressed down over the bead beater well and areas over the blister (FIG. 17C). No evidence of any label chads were found in the bay; no evidence of fragmentation of label once depressed.

After thousands of runs it is approximated that less than 0.5% of chads release into the instrument when the chad is formed by a serpentine or spiral separation line.

### Example 2

### Failure Rate of Detachable Chads

Prior to introducing the hanging chad design, Applicants tested a chad formed by perforations in an enclosed circle. Such a chad detaches/breaks from the rest of the label. Based on Table 5 below, every cartridge tested with a detachable chad failed. Further experimentation was stopped before the test instruments were damaged.

TABLE 5
Failure rate of detachable chads

| Cartridge Tested | Number of cartridges run | Run Results |
|---|---|---|
| HEPATITIS C VIRUS | 3 | Failure to achieve |
| GENOTYPE (HCVG) | | blister |
| BCID-GP | 1 | compression in |
| GASTROINTESTINAL | 2 | each replicate |
| (GI) | | |
| | TOTAL: 6 | |

### Example 3

### The force Required to Compress a Label

The force required to compress a label with a serpentine separation line is less than 3 lbs vertical force.

As shown below in Tables 6-8, the average horizontal force to compress a chad formed by a serpentine separation line is less than 3 lbs. As an approximation the horizontal force is divided by 2.2 to obtain the vertical force.

TABLE 6
Average Peak Horizontal Force (lbs)

| Run | | | | | | |
|---|---|---|---|---|---|---|
| Condition | Lysis | Oil | Binding | Recon | 1st Wash | 2nd Wash |
| With | 37.44 | 41.83 | 43.67 | 38.89 | 25.94 | 29.50 |
| Label | | | | | | |
| No Label | 32.75 | 42.00 | 37.00 | 35.75 | 24.00 | 26.75 |
| Difference | 4.69 | −0.17 | 6.67 | 3.14 | 1.94 | 2.75 |
| With | 37.40 | 34.55 | 41.45 | 33.89 | 23.28 | 31.56 |
| Label | | | | | | |
| No Label | 32.75 | 33.50 | 38.00 | 31.25 | 22.50 | 27.50 |
| Difference | 4.65 | 1.05 | 3.45 | 2.64 | 0.78 | 4.06 |
| With | 36.78 | 37.61 | 45.60 | 35.75 | 26.40 | 35.35 |
| Label | | | | | | |
| No Label | 32.25 | 36.25 | 40.75 | 32.25 | 25.50 | 32.00 |
| Difference | 4.53 | 1.36 | 4.85 | 3.50 | 0.90 | 3.35 |

TABLE 7
Average Peak Force (Lbs) Increase W/Labels Over Bays

| | Lysis | Oil | Binding | Recon | 1st Wash | 2nd Wash |
|---|---|---|---|---|---|---|
| horizontal | 4.62 | 0.75 | 4.99 | 3.09 | 1.21 | 3.39 |
| force | | | | | | |
| vertical | 2.03 | 0.33 | 2.19 | 1.36 | 0.53 | 1.48 |
| force | | | | | | |

TABLE 8
Average Peak Force (N) Increase W/Labels Over Bays

| | Average Peak Force (N) | | | | | |
|---|---|---|---|---|---|---|
| | Increase W/ Labels Over Bays | | | | | |
| | | | | | 1st | 2nd |
| | Lysis | Oil | Binding | Recon | Wash | Wash |
| Horizontal Force | 20.58 | 3.33 | 22.20 | 13.76 | 5.37 | 15.06 |
| Vertical Force | 9.03 | 1.46 | 9.74 | 6.04 | 2.36 | 6.61 |

What is claimed is:

1. A microfluidic device for detecting a human pathogen and/or genetic material thereof wherein, internal to the device comprises: A) a reaction module; B) a liquid reagent module (LRM) comprising a plurality of blisters; C) a housing having open areas over at least one of the plurality of blisters; and D) a label affixed to the housing the label comprising a chad formed by perforations in a serpentine pattern over at least a portion of at least one of the open areas.

2. The device of claim 1, wherein the chad is configured to separate but not detach from the label upon compression.

3. The device of claim 1, wherein the chad is configured to separate but not detach from the label with less than 3 lbs of compressive force.

4. The device of claim 1, wherein the label further comprises perforations forming a cross pattern over a blister.

5. The device of claim 1, wherein the human pathogen is a respiratory, gram-positive bacteria, gram-negative bacteria, fungal, Central Nervous System (CNS), or Gastrointestinal (GI) infection.

6. The device of claim 1, wherein the blisters are compressed with a compression mechanism external to the microfluidic device.

7. The device of claim 1, wherein the human pathogen is influenza A, adenovirus influenza A H1 subtype, human metapneumovirus, influenza A H3 subtype, human rhinovirus/enterovirus, influenza A 2009 H1N1 subtype, coronavirus 229e, influenza B, coronavirus HKU1, respiratory syncytial virus A, coronavirus nl63, respiratory syncytial virus B, coronavirus OC4, parainfluenza virus 1, bordetella pertussis, parainfluenza virus 2, chlamydophila pneumoniae, parainfluenza virus 3, mycoplasma pneumoniae or parainfluenza virus 4.

8. The device of claim 1, wherein the human pathogen is Bacillus cereus group, Staphylococcus epidermidis, Bacillus subtilis group, Staphylococcus lugdunensis, Corynebacterium spp., Streptococcus, Enterococcus, Streptococcus agalactiae, Enterococcus faecalis, Streptococcus anginosus group, Enterococcus faecium, Streptococcus pneumonia, Lactobacillus, Streptococcus pyogenes, Listeria, Pan Gram-negative target (at least Enterobacteriaceae, Acinetobacter, Pseudomonas, Bacteroides, Stenotrophomonas), Listeria monocytogenes, Pan Candida target (Candida albicans, Candida glabrata, Candida krusei, Candida parapsilosis), Micrococcus, Propionibacterium acnes, Staphylococcus, or Staphylococcus aureus.

9. The device of claim 1, wherein the human pathogen is Acinetobacter baumannii, Klebsiella pneumoniae, Bacteroides fragilis, Morganella morganii, Citrobacter, Neisseria meningitides, Cronobacter sakazakii, Proteus, Enterobacter cloacae, complex, Proteus mirabilis, Enterobacter (non-cloacae complex), Pseudomonas aeruginosa, Escherichia coli, Salmonella, Fusobacterium necrophorum, Serratia, Fusobacterium nucleatum, Serratia marcescens, Haemophilus influenza, Stenotrophomonas maltophilia Klebsiella oxytoca.

10. The device of claim 1, wherein the human pathogen is Candida auris, Candida albicans, Candida dubliniensis, Candida famata, Candida glabrata, Candida guilliermondii, Candida kefyr, Candida lusitaniae, Candida krusei, Candida parapsilosis, Candida tropicalis, Cryptococcus gattii, Cryptococcus neoformans, Fusarium, Malassezia furfur, Rhodotorula, or Trichosporon.

11. The device of claim 1, wherein separation of the chad from the cartridge does not prevent use of the cartridge.

12. The device of claim 2, wherein the label further comprises a machine readable identifier which does not overlap the perforations forming the chad.

13. The device of claim 1, wherein compression of the chad does not cause the assay information and identification on the label to become unreadable.

14. The device of claim 1, wherein compression of the chad causes assay information and identification on the label to become unreadable and prevents reuse of the cartridge.

15. A fluidic cartridge comprising: a body comprising a recess comprising a fluid filed compressible element disposed within the recess and the body comprising a label the label comprising a hanging chad that is at least partially within the recess wherein the chad does not separate from the label.

16. The cartridge of claim 15, the hanging chad causes assay information and identification on the label to become unreadable and prevents reuse of the cartridge.

17. The cartridge of claim 15, wherein the human pathogen is a respiratory, gram-positive bacteria, gram-negative bacteria, fungal, Central Nervous System (CNS), or Gastrointestinal (GI) infection.

18. A microfluidic device for detecting a human pathogen and/or genetic material thereof comprising a label comprising a chad formed by a serpentine separation line which allows the chad to separate but not detach from the label upon compression.

19. The device of claim 18, wherein the human pathogen is a respiratory, gram-positive bacteria, gram-negative bacteria, fungal, Central Nervous System (CNS), or Gastrointestinal (GI) infection.

20. The device of claim 18, wherein compression of the chad causes assay information and identification on the label to become unreadable and prevents reuse of the cartridge.
